(19) United States
(12) Patent Application Publication
(10) Pub. No.: US 2014/0219361 A1
(43) Pub. Date: Aug. 7, 2014

(54) IMAGE DATA ENCODING FOR ACCESS BY RASTER AND BY MACROBLOCK

(71) Applicant: Samplify Systems, Inc., San Jose, CA (US)

(72) Inventors: ALBERT W. WEGENER, APTOS HILLS, CA (US); ALLAN M. EVANS, CUPERTINO, CA (US)

(73) Assignee: Samplify Systems, Inc., SAN JOSE, CA (US)

(21) Appl. No.: 14/162,075

(22) Filed: Jan. 23, 2014

Related U.S. Application Data
(60) Provisional application No. 61/759,805, filed on Feb. 1, 2013.

(51) Int. Cl. H04N 19/423; H04N 19/46

(52) U.S. Cl. CPC H04N 19/00484; H04N 19/00545
USPC 375/240.24

(57) ABSTRACT

Access encoding/decoding of image data has at least two preferred access modes, raster access and macroblock access. Arriving rasters containing pixels from an image sensor are converted to encoded macroblocks to support later random macroblock and raster access. Encoded macroblocks can be randomly accessed (read from or written to memory) by block-based video compression algorithms, such as H.264. Encoded macroblocks can also be decoded raster by raster for raster-oriented display devices. Access encoding/decoding may be implemented in a microprocessor, graphics processor, digital signal processor, FPGA, ASIC, or SoC. Access encoding/decoding of image data or reference frames can reduce memory and storage bottlenecks, processor access time, and processor and memory power consumption. A user interface can allow users to control the tradeoff between decoded video quality and battery life for a mobile device. This abstract does not limit the scope of the invention as described in the claims.

### RELATED APPLICATIONS

This application claims benefit of U.S. Provisional Patent Application No. 61/759,805 filed on 1 Feb. 2013, which application is incorporated by reference herein.

### BACKGROUND

The technology described herein encodes pixel data of an image or video frame to support multiple access patterns, including access in raster and macroblock formats, for image data that are captured, processed, stored, or displayed in a computing system.

In today's (2013) imaging applications, it is often desirable to capture, to process, to display, and to store images in mobile, portable, and stationary devices. The prodigious amount of pixels captured during image and video processing can create bottlenecks for system speed and performance in such devices. In imaging applications, at least two access patterns are common: raster-based access (accessing sequential pixels along successive horizontal rows, or rasters, of image frames) and block-based (accessing square [or rectangular] subsets of pixels, where the entire image frame is tiled with squares [or rectangles]). Compression of image frames using standard video compression algorithms such as MPEG2 and H.264 reduces these bottlenecks at the cost of additional computations and reference frame storage (previously decoded image frames). In video applications, if lossless or lossy compression of macroblocks within reference frames were used to reduce memory capacity requirements and to reduce memory access time, it would be desirable that such macroblock encoding be computationally efficient in order to minimize demands on computing resources. It would be further desirable that the macroblock encoding method support both raster-based and block-based access patterns.

Imaging systems are ubiquitous in both consumer and industrial applications using microprocessors, computers, and dedicated integrated circuits called systems-on-chip (SoCs) or application-specific integrated circuits (ASICs). Such imaging systems can be found in personal computers, laptops, tablets, and smart phones; in televisions, satellite and cable television systems, and set-top boxes (STBs); and in industrial imaging systems that include one or more cameras and a network for capturing video from monitored systems as diverse as factories, office buildings, and geographical regions (such as when unmanned aerial vehicles or satellites perform reconnaissance). Such imaging and video systems typically capture frames of image data from image sensors that require raster-based access. Similarly, images in such imaging and video systems typically use monitors or displays on which users view the captured still images or videos. Because digital video systems require memory access to tens or even hundreds of Megabytes (MByte) per second for recording or playback, several generations of video compression standards, including Moving Picture Experts Group (MPEG and MPEG2), ITU H.264, and the new H.265 (High Efficiency Video Codec) were developed to reduce memory bandwidth and capacity requirements of video recording and playback. These video processing standards achieve compression ratios between 10:1 and 50:1 by exploiting pixel similarities between successive frames. Many pixels in the current frame can be identical, or only slightly shifted horizontally and/or vertically, to corresponding pixels in previous frames. The aforementioned image compression standards operate by comparing areas of similarity between subsets (typically called macroblocks, or MacBlks) of the current image frame to equal-sized subsets in one or more previous frames. Macroblocks are the basic element used for many prediction and motion estimation techniques in video codec processes. In the remainder of this document, we use the abbreviation ‘MacBlk’ for the term ‘macroblock’, to distinguish it from the abbreviation ‘MByte’ for the term ‘Megabyte’ (10⁶ Bytes). The encoding process that searches for, and then determines, the location of similar MacBlks is commonly called Motion Estimation (ME). The decoding process that retrieves MacBlks from prior frames while creating MacBlks for the current frame is commonly called Motion Compensation (MC). Both ME and MC processes typically access pixels from prior frames in 16×16 pixel MacBlks. During both encoding and decoding, prior video frames whose MacBlks are searched (encoding) or used as a reference (decoding) are called reference frames. As of today (2013), ME and MC processes access uncompressed MacBlks (pieces of reference frames) in main memory, also called dynamic random access memory (DRAM) or double data rate (DDR) memory.

Especially in mobile and portable devices, where only a limited amount of power is available due to battery limitations, it is desirable to use as little power for video recording and playback as possible. A significant (>30%) amount of power is consumed during video encoding when the ME process accesses MacBlks in reference frames stored in off-chip DDR memory, and during video decoding when the MC process accesses MacBlks in reference frames stored in off-chip DDR memory. In today's portable computers, tablets, and smart phones, the video encoding and decoding process is often orchestrated by one or more cores of a multi-core integrated circuit (IC).

The present specification describes an access encoder for performing low complexity encoding of reference frame MacBlks in a user-programmable way that supports both raster and MacBlk-based access. As MacBlks from reference frames are written to DDR memory, they are encoded according to user-selected parameters, such as the desired encoding ratio or the desired image quality (optionally including lossless compression). Similarly, as encoded MacBlks from reference frames are read from off-chip DDR memory, they are decoded according to the parameters selected or calculated during prior MacBlk encoding. The access encoder organizes the pixel data in a manner that supports both raster-based access and macroblock-based access. In prior video processing systems, additional steps such as transposition are typically required to convert between the decoded macroblocks in reference frames (stored in MacBlk access patterns for the convenience of standard video encoding and decoding) and the raster-based access preferred by image sensors and image displays and monitors. The access encoder described herein does not require such steps.

Commonly owned patents and applications describe a variety of compression techniques applicable to fixed-point, or integer, representations of numerical data or signal samples. These include U.S. Pat. No. 5,839,100 (the '100 patent), entitled “Lossless and loss-limited Compression of Sampled Data Signals” by Wegener, issued Nov. 17, 1998. The commonly owned U.S. Pat. No. 7,009,533, (the '533 patent) entitled “Adaptive Compression and Decompression of Bandlimited Signals,” by Wegener, issued Mar. 7, 2006, incorporated herein by reference, describes compression algorithms that are configurable based on the signal data characteristic and measurement of pertinent signal characteristics for compression. The commonly owned U.S. Pat. No. 8,301,803 (the '803 patent), entitled “Block Floating-point Compression of Signal Data,” by Wegener, issued Apr. 28, 2011, incorporated herein by reference, describes a block-floating-point encoder and decoder for integer samples. The commonly owned U.S. patent application Ser. No. 13/534,330 (the '330 application), filed Jun. 27, 2012, entitled “Computationally Efficient Compression of Floating-Point Data,” by Wegener, incorporated herein by reference, describes algorithms for direct compression floating-point data by processing the exponent values and the mantissa values of the floating-point format. The commonly owned patent application Ser. No. 13/617,061 (the '061 application), filed Sep. 14, 2012, entitled “Conversion and Compression of Floating-Point and Integer Data,” by Wegener, incorporated herein by reference, describes algorithms for converting floating-point data to integer data and compression of the integer data.

The commonly owned patent application Ser. No. 13/617,205 (the '205 application), filed Sep. 14, 2012, entitled “Data Compression for Direct Memory Access Transfers,” by Wegener, incorporated herein by reference, describes providing compression for direct memory access (DMA) transfers of data and parameters for compression via a DMA descriptor. The commonly owned patent application Ser. No. 13/616,898 (the '898 application), filed Sep. 14, 2012, entitled “Processing System and Method Including Data Compression API,” by Wegener, incorporated herein by reference, describes an application programming interface (API), including operations and parameters for the operations, which provides for data compression and decompression in conjunction with processes for moving data between memory elements of a memory system.

The commonly owned patent application Ser. No. 13/358,511 (the '511 application), filed Jan. 12, 2012, entitled “Raw Format Image Data Processing,” by Wegener, incorporated herein by reference, describes encoding of image sensor rasters during image capture, and the subsequent use of encoded rasters during image compression using a standard image compression algorithm such as JPEG or JPEG2000.

In order to better meet MacBlk access requirements during video capture, processing, and display, and to reduce memory utilization and complexity during both raster-based and block-based access, a need exists for a flexible, computationally efficient MacBlk encoding and decoding method that supports both raster and MacBlk access patterns.

### SUMMARY

In one embodiment, the access encoder described herein is applied to unencoded or previously decoded image data organized as macroblocks. The access encoder encodes the macroblocks for storage in memory in an order that supports both raster and MacBlk access to the stored, encoded macroblocks. Supplemental location information is also stored to be used for retrieving the desired portion of image data in macroblock or raster formats for further processing or display. In one aspect, MacBlk encoding and decoding for image data may be implemented using resources of a computer system.

Other aspects and advantages of the present invention can be seen on review of the drawings, the detailed description and the claims, which follow.

### BRIEF DESCRIPTION OF THE DRAWINGS

FIG. 1 is a block diagram of a computing system that captures, processes, stores and displays digital image data, including an access encoder and decoder, in accordance with a preferred embodiment.

FIG. 2 illustrates an example of a frame of pixels.

FIG. 3 illustrates an example of a frame of pixels organized by rasters.

FIG. 4 illustrates an example of a frame of pixels organized by macroblocks.

FIG. 5 illustrates examples of partitions of macroblocks.

FIG. 6 shows examples of the number of DDR pages for encoded reference frames, in accordance with a preferred embodiment.

FIG. 7 shows examples of DDR access times for various compression ratios.

FIG. 8 illustrates examples of macroblock access using a directory of pointers.

FIG. 9 illustrates several examples of packing pixel data into a packet.

FIG. 10 illustrates an example of accessing encoded sub-blocks within an encoded macroblock.

FIG. 11 lists assumptions for an example of macroblock encoding.

FIG. 12 illustrates an example of forming encoded macroblocks from raster data arriving from an image sensor.

FIG. 13 illustrates an example of accessing encoded macroblocks for ME and MC operations by standard video compression and decompression processing.

FIG. 14 illustrates an example of decoding rasters from encoded macroblocks for a display device.

FIG. 15a illustrates an example of a video encoder where previously decoded reference frames are stored in a memory.

FIG. 15b illustrates an example of a video decoder where previously decoded reference frames are stored in a memory.

FIG. 15c illustrates an example of the access encoder and access decoder providing memory access during the video decoder's motion compensation process.

FIG. 16 illustrates examples of the three types of MacBlks that are processed by the access encoder/decoder for video decoding.

FIGS. 17a and 17b illustrate examples of systems in which a video encoder and a video decoder include an access encoder and an access decoder.

FIG. 18 is a block diagram of the access encoder, in accordance with a preferred embodiment.

FIG. 19 is a block diagram of an access decoder, in accordance with a preferred embodiment.

### DETAILED DESCRIPTION

Embodiments of the access encoder and access decoder described herein may encompass a variety of computing architectures that represent image data using a numerical representation. Image data may include both integer data of various bit widths, such as 8 bits, 10 bits, 16 bits, etc. and floating-point data of various bit widths, such as 32 bits or 64 bits, etc. The image data may be generated by a variety of applications and the computing architectures may be general purpose or specialized for particular applications. The image data may result from detected data from a physical process, image data created by computer simulation or intermediate values of data processing, either for eventual display on a display device or monitor, or simply for intermediate storage. For example, the numerical data may arise from image sensor signals that are converted by an analog to digital converter (ADC) in an image sensor to digital form, where the digital samples are typically represented in an integer format. Common color representations of image pixels include RGB (Red, Green, Blue) and YUV (brightness/chroma1/chroma2). Image data may be captured and/or stored in a planar format (e.g. for RGB, all R components, followed by all G components, followed by all B components) or in interleaved format (e.g. a sequence of {R,G,B} triplets).

An image frame has horizontal and vertical dimensions H_DIM and V_DIM, respectively, as well as a number of color planes N_COLORS (typically 3 [RGB or YUV] or 4 [RGBA or YUVA], including an alpha channel). H_DIM can vary between 240 and 2160, while V_DIM can vary between 320 and 3840, with typical H_DIM and V_DIM values of 1080 and 1920, respectively, for a 1080p image or video frame. A single 1080p frame requires at least 1080×1920×3 Bytes=6 MByte of storage, when each color component is stored using 8 bits (a Byte). Video frame rates typically vary between 10 and 120 frames per second, with a typical frame rate of 30 frames per second (fps). As of 2013, industry standard video compression algorithms called H.264 and H.265 achieve compression ratios between 10:1 and 50:1 by exploiting the correlation between pixels in MacBlks of successive frames, or between MacBlks of the same frame. The compression or decompression processing by industry-standard codecs require storage of the last N frames prior to the frame that is currently being processed. These prior frames are stored in off-chip memory and are called reference frames. The access encoder described below accelerates access to the reference frames between a processor and off-chip memory to reduce the required bandwidth and capacity for MacBlks in reference frame.

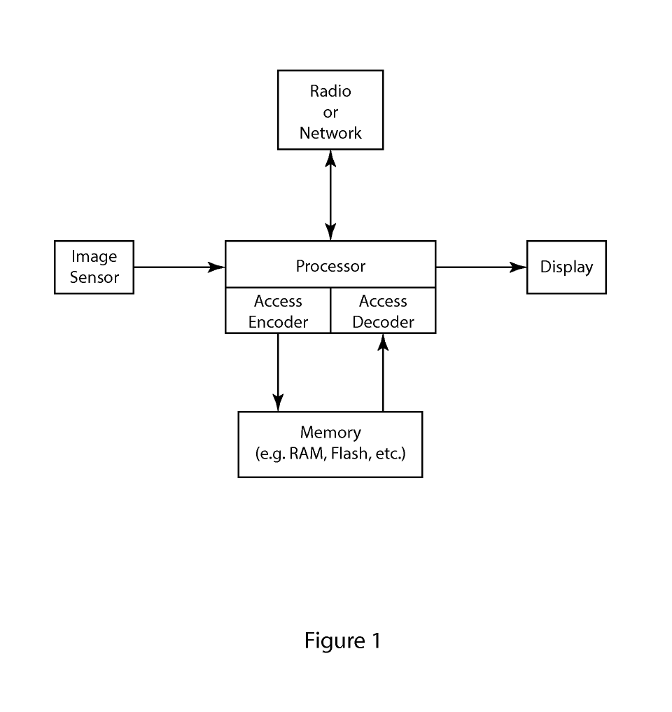

FIG. 1 is a block diagram of a computing system that captures, processes, stores, and displays digital image data, including an access encoder and decoder, in accordance with a preferred embodiment. An image sensor provides pixels to a processor, typically raster by raster, for each captured image frame. A display or monitor receives pixels from a processor, typically raster by raster, for each image frame to be displayed. A processor responds to user inputs (not shown) and orchestrates the capture, processing, storage, and display of image data. A memory is used to store reference frames and other intermediate data and meta-data (such as date and time of capture, color format, etc.) and may optionally also be used to store a frame buffer of image data just prior to image display, or just after image capture. An optional radio or network interface allows the processor to transmit or to receive other image data in any format from other sources such as the Internet, using wired or wireless technology. The access encoder encodes the image data for storage in the memory and generates supplemental information for the encoded image data. The image data to be encoded may be in raster format, such as when received by the image sensor, or in macroblock format, such as unencoded video frame data. The access encoder generates supplemental information for the encoded image data. The processor may use the supplemental information to access the encoded image data in raster format or in macroblock format, as needed for the application processing. The access decoder decodes the encoded image data and provides the decoded image data in raster or macroblock format. The access decoder may provide the decoded image data in raster format, as needed for display, or in macroblock format, as needed for macroblock-based video encoding operations.

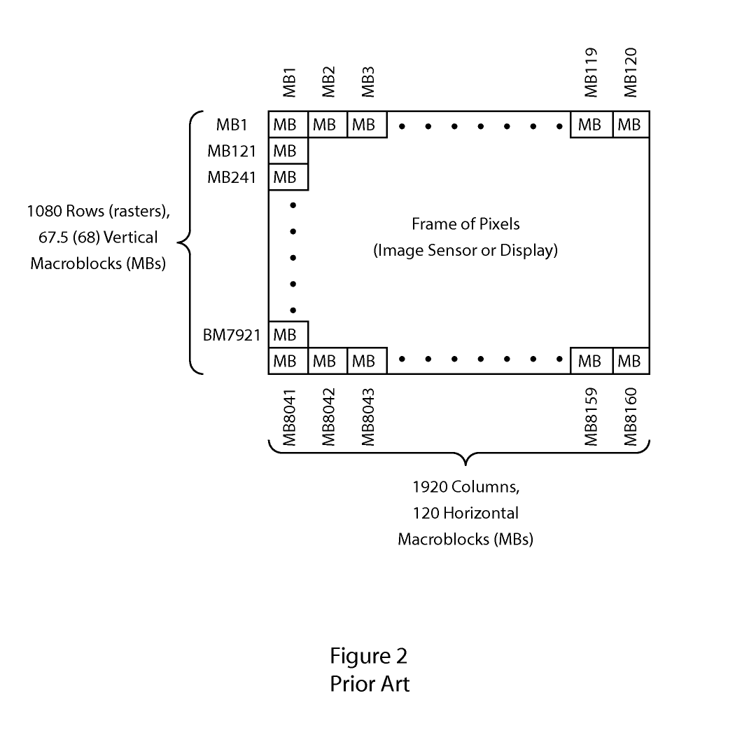

FIG. 2 illustrates the organization of an example of a 1080p image frame having 1080 rows (rasters) and 1920 pixels per row (raster). FIG. 2 also shows how macroblocks of 16×16 pixels are overlaid on the image data, creating 120 horizontal MacBlks (per 16 vertical rasters) and 68 vertical MacBlks (per 16 horizontal rasters), for a total of 8,160 MacBlks per 1080p frame.

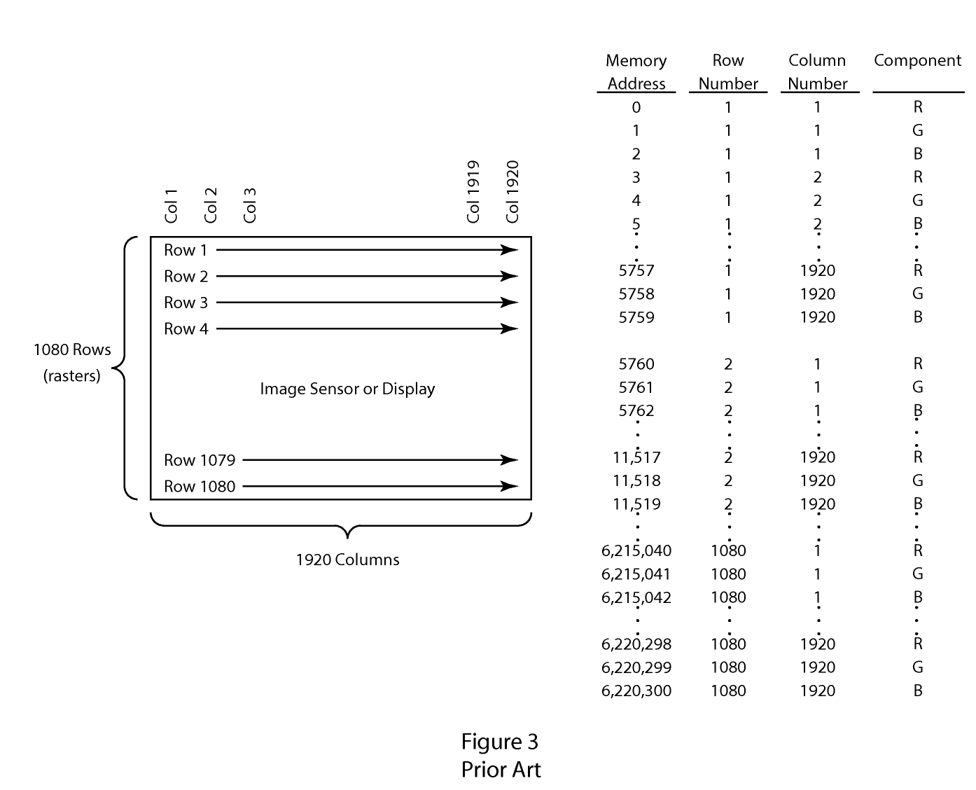

FIG. 3 illustrates an example of a 1080p image frame being received from an image sensor, or being provided to an image display or monitor, in “raster order.” The table in FIG. 3 lists the preferred DDR memory address for each pixel {row #, column #} and each color component (R, G, and B) that facilitates raster access. The first pixel to be received (from the image sensor) or sent (to the display or monitor) is Row 1, Col 1, then Row 1, Col 2, etc. until the pixel at Row 1, Col 1920 has been received or sent. Next, Row 2's pixels are sent, from Column 1 to Column 1920. Subsequently Rows 2 thru 1080 are sent, with pixels from Column 1 to Column 1920 in each case. In the example shown in FIG. 3, color components are interleaved, but in another example the MacBlk's pixels could be stored in planar order (all R pixels for a MacBlk, followed by all G pixels, then followed by all B pixels).

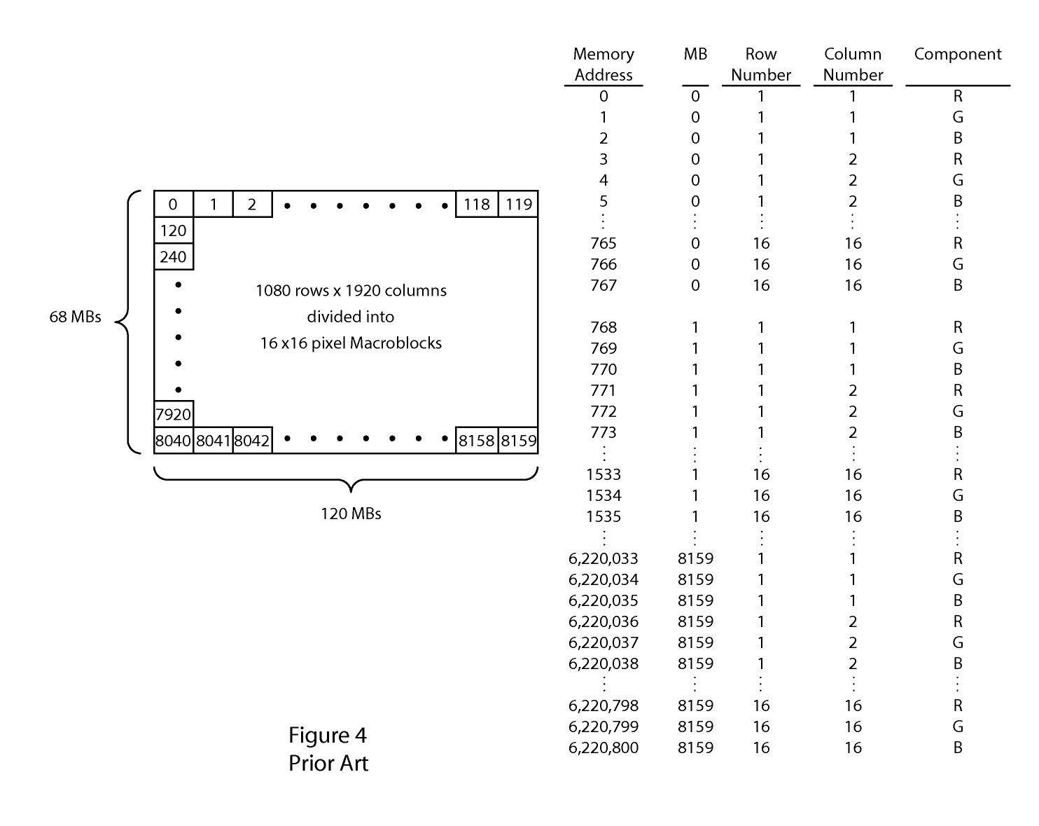

FIG. 4 illustrates an example of image data access being performed in MacBlk order. The left-hand drawing of FIG. 4 shows how 8,160 MacBlks overlay an example 1080p frame. The table of FIG. 4 indicates the memory addresses that contain each MacBlk's pixels in a way that facilitates MacBlk access. Note that the memory address sequence for rasters (FIG. 3) differs significantly from the memory address sequence for MacBlks (FIG. 4), although both representations store the same amount of image data (pixels).

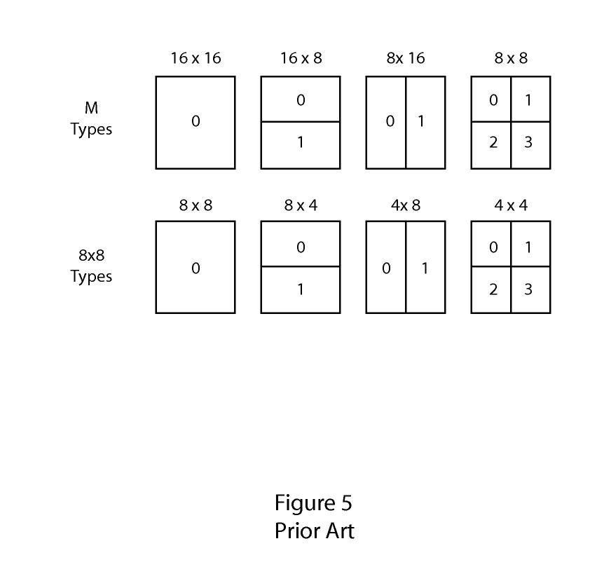

FIG. 5 illustrates examples of partitions of a 16×16 pixel H.264 MacBlk into smaller groups, such as two 16×8 sub-blocks, two 8×16 sub-blocks, etc. These partitions are commonly used in H.264 video compression algorithms. H.264's 8×8 sub-blocks can be optionally further sub-divided as shown in the row labeled “8×8 Types.” The H.264 video encoding standard provides optional sub-block access within MacBlks in order to minimize the amount of reference frame pixels that must be fetched during the H.264 MC decoding process, especially when the corners of reference MacBlks are created using two or more reference MacBlks.

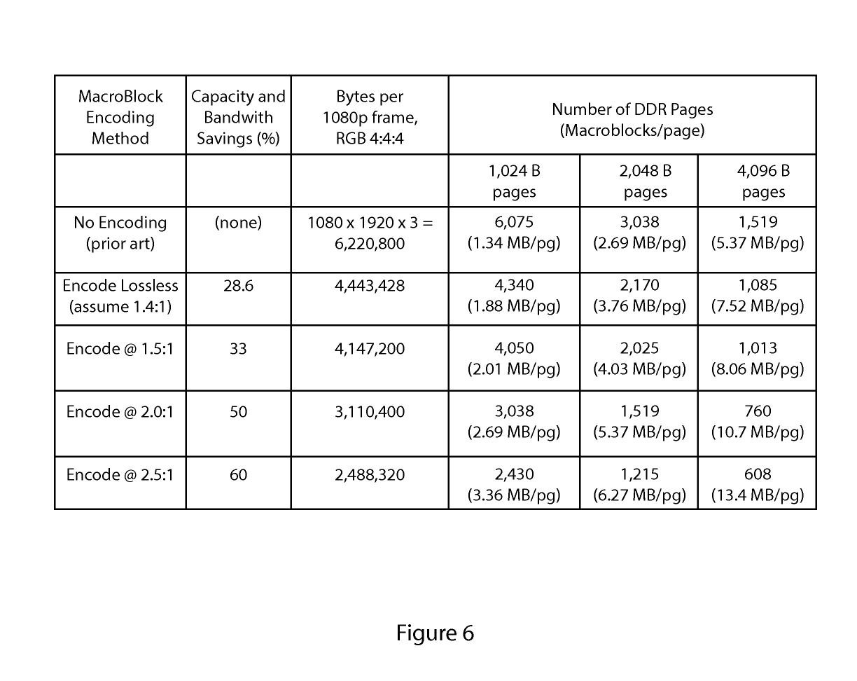

FIG. 6 provide a table of reference frame encoding results, for examples at four different encoding (compression) ratios (1.4:1, 1.5:1, 2:1, and 2.5:1). These examples show that the access encoder applied to the reference frame reduces the number of DDR memory pages required to store an example 1080p frame. DDR and LPDDR memory is sold in a variety of capacities, word widths, and page sizes, including memory that stores 1,024 Bytes, 2,048 Bytes, or 4,096 Bytes per DDR page. Embodiments of the access encoder may allow users to specify the encoding mode (lossless or lossy), and for lossy encoding mode, the desired encoding ratio or desired image quality. Above a certain video-material-dependent lossy encoding ratio, users may object to the image quality of the decoded video that uses lossy-encoded reference frames. Embodiments of the access encoder may allow users to trade off DDR bandwidth, capacity, and power consumption with image quality in a flexible, user-controlled way.

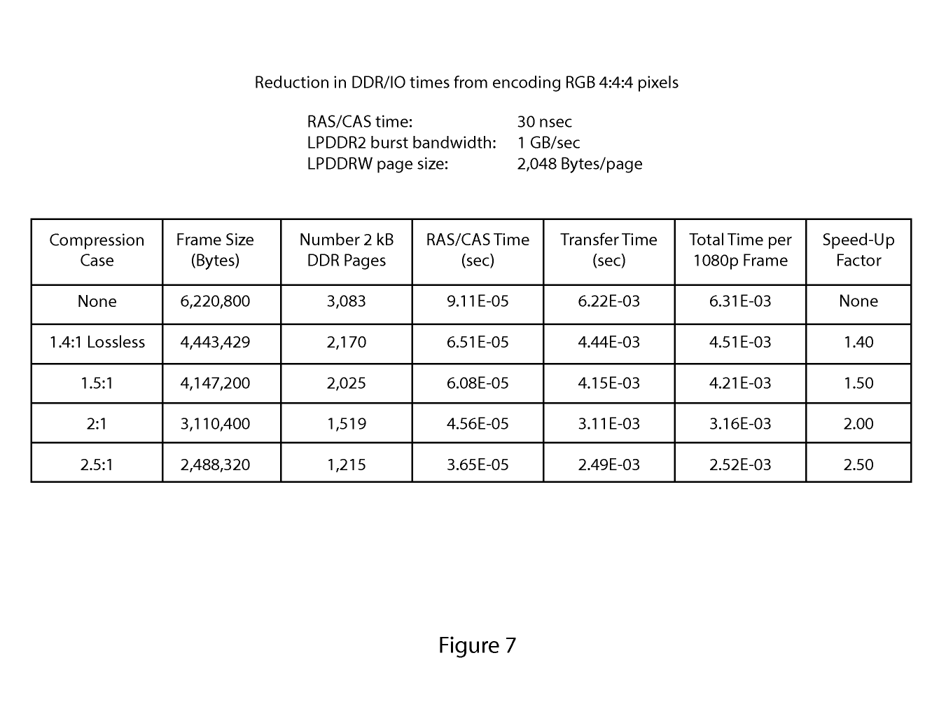

FIG. 7 gives examples of encoding (compression) ratios and reductions of the total time required to read or write a reference frame. Read or Write access to DDR and/or LPDDR memory pages require two commands:
An “ACTIVATE” command to open a new DDR memory page, and
A “READ” or “WRITE” command that reads or writes bits or Bytes from the open DDR page.
   The “ACTIVATE” step (also called the Row Address Strobe/Column Address Strobe [RAS/CAS] setup) requires a fixed amount of time to open a DDR page—30 nsec in the example of FIG. 7. After the DDR page has been opened, the “READ” or “WRITE” commands access the Bytes on the open DDR page at a rate of about 1 GB/sec (for example). Since reference frames are smaller when the access encoder is applied, encoded MacBlks can be transferred more quickly than un-encoded reference frames. By reducing the time required to transfer reference frames between a processor and memory, the access encoder enables video encoding and playback at lower power or at higher frame rates.

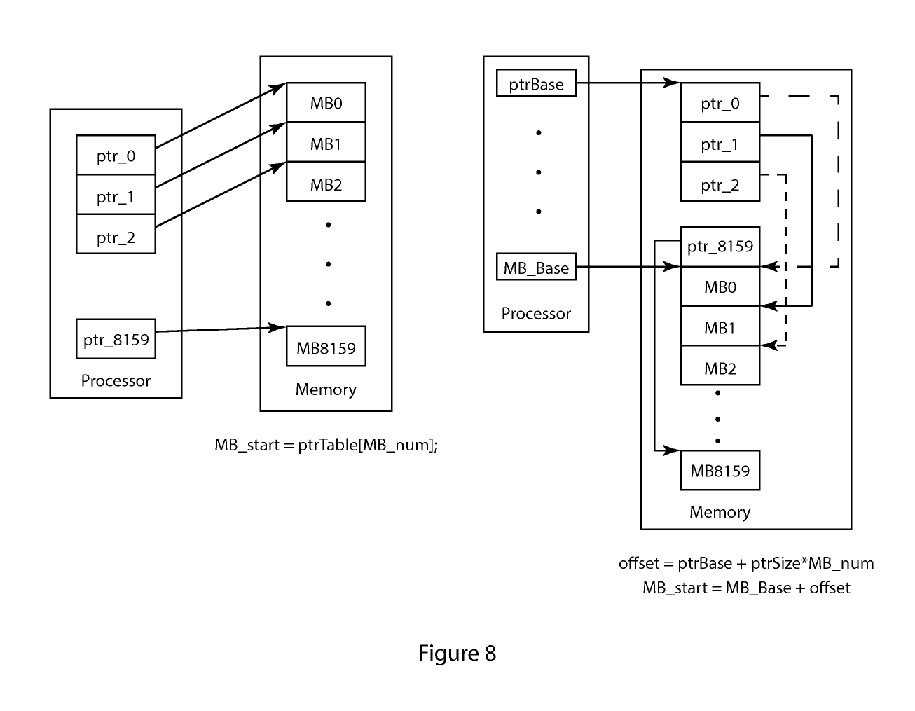

FIG. 8 illustrates examples of directories of pointers to determine start addresses of encoded MacBlks stored in memory. During MacBlk encoding, the encoded size can vary from MacBlk to MacBlk, because some MacBlks are more compressible than others. When the encoded MacBlk size varies, and when MacBlks are packed together sequentially in memory, the MacBlk start addresses can vary across MacBlks. The access encoder may calculate entries for the directory of pointers to be stored as supplemental information for the encoded MacBlks. For retrieving the encoded MacBlks, the access decoder uses the directory of pointers to determine start addresses of the desired MacBlks. As shown in FIG. 8, the directory of addresses or pointers contains an entry for each MacBlk with its start address in memory. An example 1080p reference frame requires 8160 such addresses or pointers, one per MacBlk in the frame. These pointers can either be stored in on-chip (left-hand drawing of FIG. 8) or off-chip (right-hand drawing of FIG. 8) memory. Since on-chip memory is typically 10× faster than off-chip memory, it may seem preferable to store the encoded reference frame MacBlk pointers in on-chip memory. However, the speed penalty for storing MacBlk pointers in off-chip memory is small, since accessing the proper address pointer for a user-requested MacBlk only involves fetching a single MacBlk pointer (typically 4 Bytes per pointer) from a known, or easily calculable, location in off-chip memory. For retrieving and decoding, the access decoder retrieves the encoded MacBlk start address from the directory of MacBlk pointers, fetches the requested MacBlk's contents from off-chip memory and decodes the MacBlk. The time required to access the MacBlk's pointer is small when compared to the time required to access the encoded MacBlk contents. For example, accessing the MacBlk contents can vary from 512 B (uncompressed MacBlk containing YUV 4:4:4, 8 bits per component) to 64 B (an access encoded YUV 4:2:0 MacBlk with 8 bits per component, with a compression ratio of 4:1).

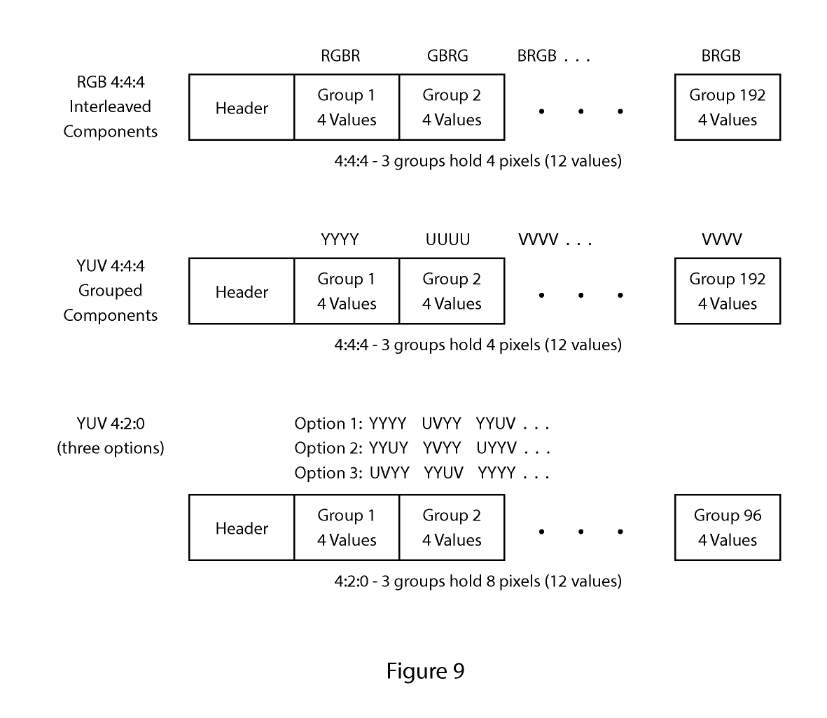

FIG. 9 illustrates several examples of packing pixel data into a packet. The access encoder may apply the techniques described in the '511 application and the '803 application. The '511 application describes algorithms for compressing and storing image data. The '803 patent describes block floating point encoding, that compresses and groups four mantissas (differences) at a time. The access encoder may compress the image data by computing first or second order differences (derivatives) between sequences of samples of the same color components, as described in the '511 application. The access encoder may apply block floating point encoding to the difference values, as described in the '803 patent. The block floating point encoder groups resulting difference values and finds the maximum exponent value for each group. The number of samples in the encoding groups is preferably four. The maximum exponent corresponds to the place value (base 2) of the maximum sample in the group. The maximum exponent values for a sequence of the groups are encoded by joint exponent encoding. The mantissas in the encoding group are reduced to have the number of bits indicated by the maximum exponent value for the group. The groups may contain different numbers of bits representing the encoded samples. FIG. 9 labels such grouped components “Group 1, Group 2,” etc. The access encoder allows flexible ordering of the groups of compressed color components. In the examples of FIG. 9, three groups of 4 encoded components can store image components in any of the following ways:
a. Example 1, RGB 4:4:4: {RGBR}, {GBRG}, {BRGB}
b. Example 2, YUV 4:4:4: {YYYY}, {UUUU}, {VVVV}
c. Example 3, YUV 4:2:0: {YYYY}, {UVYY}, {YYUV}
d. Example 4, YUV 4:2:0: {YYUY}, {YVYY}, {UYYV}
e. Example 5, YUV 4:2:0: {UVYY}, {YYUV}, {YYYY}
   The access encoder may form a packet containing a number of the groups of encoded data for all the color components of the pixels in one macroblock. For RGB 4:4:4 and YUV 4:4:4, the number of groups of encoded data is preferably 192. For YUV 4:2:0, the number of groups is preferably 96. The packets may include a header that contains parameters used by the access decoder for decoding the groups of encoded data.

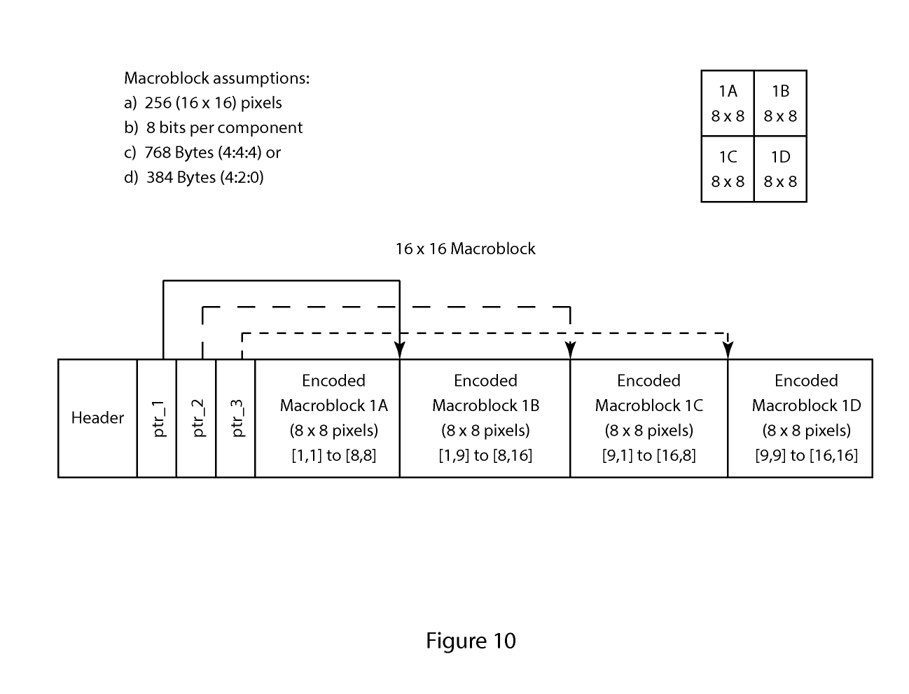

FIG. 10 illustrates an example of accessing encoded sub-blocks within an encoded macroblock. In particular, FIG. 10 illustrates how four 8×8 sub-block comprising a 16×16 MacBlk can be accessed by adding three additional pointers (Ptr_{—}1, Ptr_{—}2, and Ptr_{—}3) along with encoded MacBlk data. In a preferred embodiment, these additional pointers are stored directly after the header of the encoded MacBlk. A preferred embodiment of the access encoder would include a “pointer present” bit in the header of each encoded macroblock; when this bit is set (=1), the additional pointers are present; when the bit is clear (=0), the additional pointers are absent. Each 8×8 sub-block contains 64 encoded pixels. Within each 8×8 sub-block, pixels would preferably be stored in pixel order shown in FIG. 10, using either interleaved color components (RGB/RGB/ . . . or YYYYUV/YYYYUV/ . . . ) or planar color components (all R components, followed by all G components, followed by all B components; all Y components, followed by all U components, followed by all V components). Access to 8×8 sub-blocks is useful for H.264 video decoding where portions of reference frames are retrieved from off-chip memory. During the MC phase of H.264 video decoding, randomly located MacBlks are retrieved from previously decoded reference frames. When MacBlks from reference frames do not perfectly align with 16×16 MacBlk grid points, such as when the current MacBlk being decoded refers to a reference MacBlk that overlaps multiple MacBlks (a reference MacBlk offset such as {8, 8} pixels would cause such an overlap), not all of a reference MacBlk will be used to create the current frame's MacBlk. In such cases it is preferable to fetch a sub-block. The access decoder supports sub-block access using the pointers Ptr_{—}1, Ptr_{—}2 and Ptr_{—}3 to retrieve one of the 8×8 encoded sub-blocks of FIG. 10 from an encoded MacBlk. The access decoder reduces the time spent reading encoded MacBlks (or subsets thereof) from DDR memory. For example, if the third 8×8 pixel sub-block 1C is requested, the access decoder would:
1. Calculate the MacBlk start address (as previously described with respect to FIG. 8),
2. Read the encoded block header (labeled “Header” in FIG. 10),
3. Skip Ptr_{—}1 and fetch Ptr_{—}2,
4. Decode Encoded sub-block 1C starting at the Ptr_{—}2 address.
   Sub-block pointers can contain either the Byte offset from the start of the MacBlk, or the size of each sub-block (from which the offset of each sub-block can be calculated). A preferred embodiment of the access encoder would store the sub-block size, rather than the sub-block pointer itself, because the sub-block size can typically fit into a single Byte, whereas the sub-block pointer may require multiple Bytes.

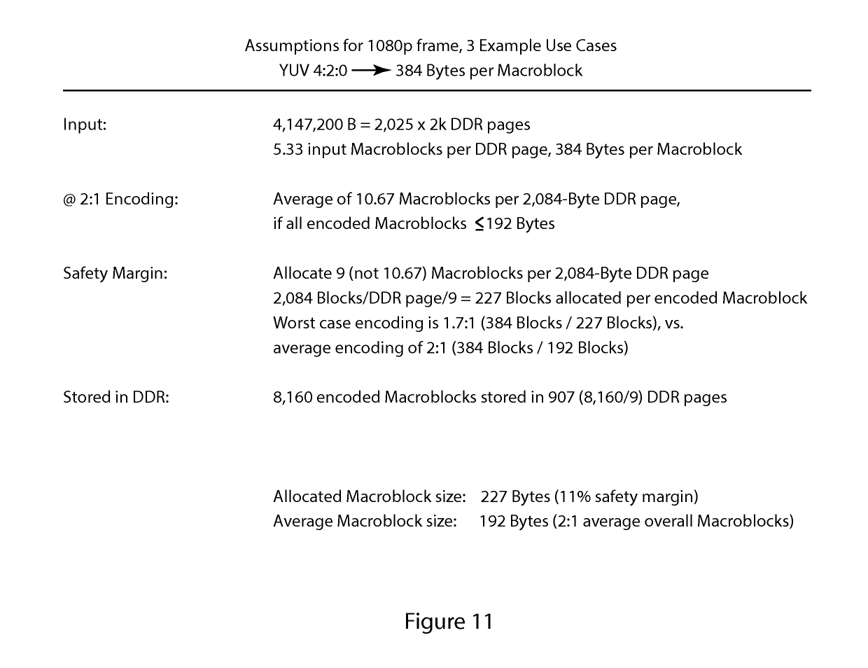

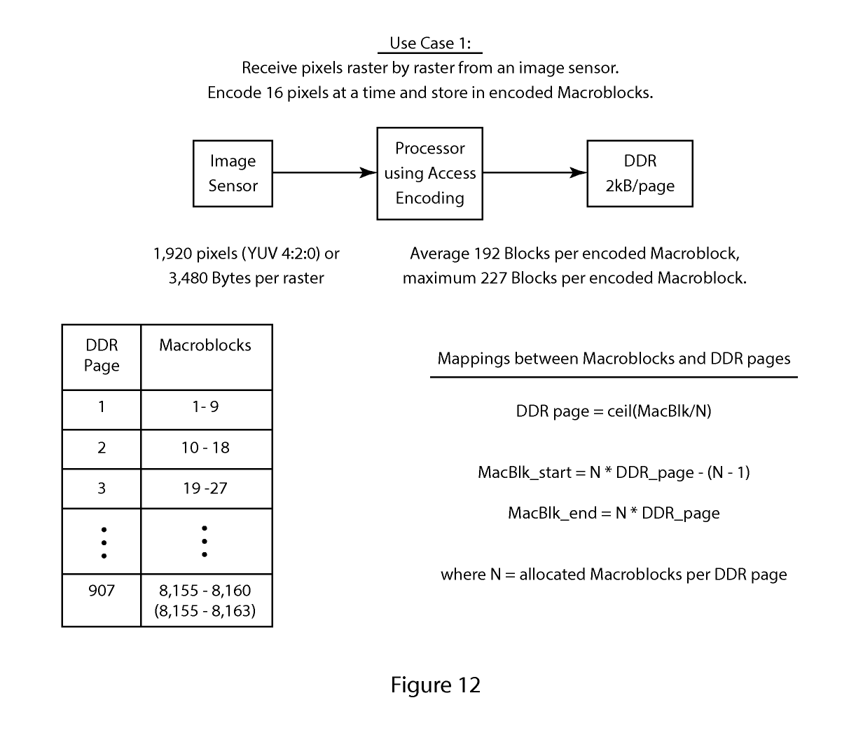

FIG. 11 summarizes the assumptions for access encoding examples described with respect to FIGS. 12-14. In this example, we assume a 1080p frame using YUV 4:2:0 color encoding will be encoded at an encoding ratio of 2:1. In this example, the input frame requires 4,147,200 Bytes, which can be stored in 2,025 DDR memory pages, where each page (in this example) holds 2,048 Bytes. If every 384-Byte YUV 4:2:0 input MacBlk were encoded at 2:1, it would ideally fit into 192 Bytes or less. In this case, each 2,048-Byte DDR page could hold 10.67 MacBlks. However, since the encoded MacBlk size may vary from MacBlk to MacBlk, it is possible that one or more encoded MacBlks may require more than 192 Bytes per encoded MacBlk. FIG. 11 indicates that the access encoder can provide a safety margin for encoded MacBlks stored in DDR pages. Specifically, in this example the access encoder will to store only nine encoded MacBlks per DDR page, instead of 10 encoded MacBlks per DDR page, to provide room for encoded MacBlks that exceed 192 Bytes. The access encoder will thus reserve 2048/9=227 Bytes per MacBlk, instead of 2048/10=205 Bytes per MacBlk. Including this safety margin, start addresses of encoded MacBlks will be spaced 227 Bytes apart within each DDR page. Thus to store all 8,160 encoded MacBlks using nine encoded MacBlks per DDR page, this example will require 907 DDR pages (8,160/9).

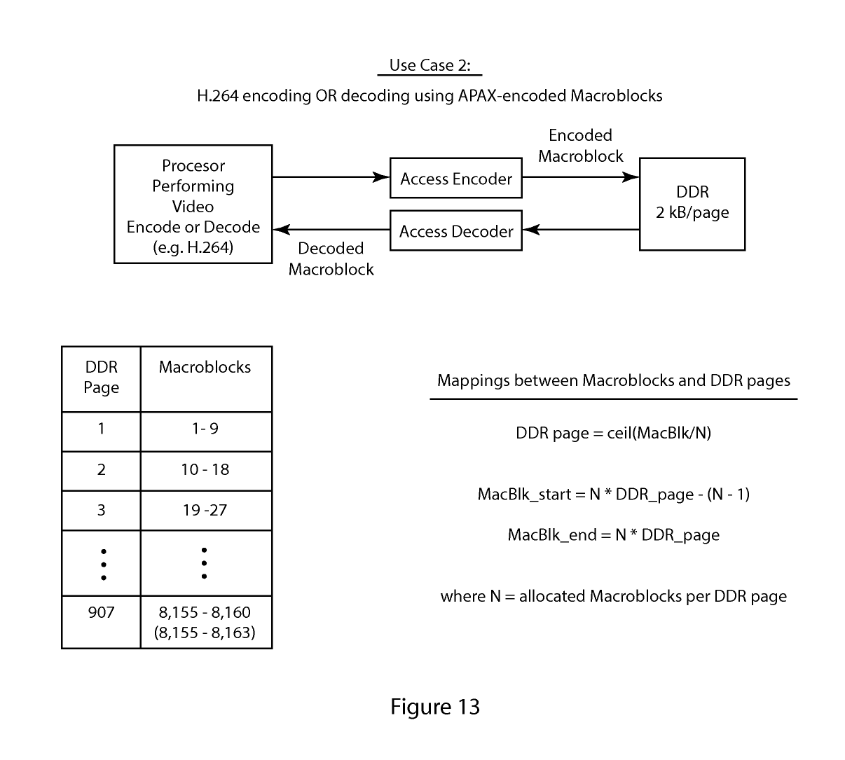

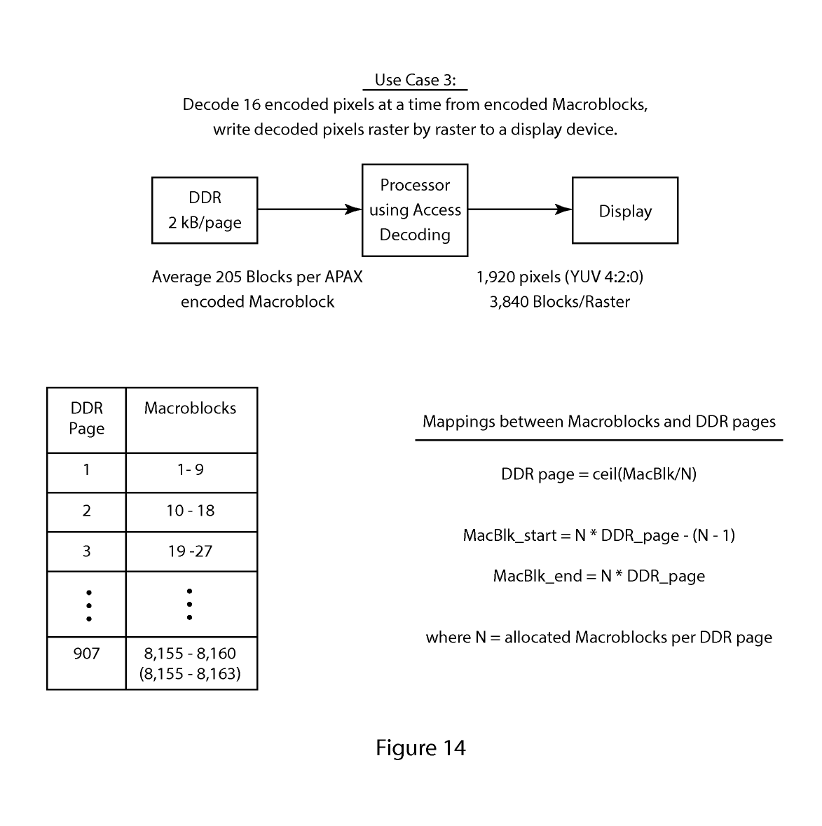

FIGS. 12, 13, and 14 present examples of three use cases of the access encoder/decoder:
Use case 1: FIG. 12 illustrates an example of access encoding applied to 16 rasters of image sensor samples, containing 1,920 pixels per raster, to produce 120 encoded MacBlks.
Use case 2: FIG. 13 illustrates an example of access encoder and decoder applied to storage and retrieval of MacBlks for H.264 or similar video codec processes where random access to MacBlks in reference frames is used in the processes. The access encoder supports rapid storage of MacBlks of a reference frame. The access decoder can randomly access any encoded MacBlk of a reference frame, to provide data for the ME processes of video compression or the MC processes of video decompression.
Use case 3: FIG. 14 illustrates an example of decoding 16 display rasters containing 1,920 pixels per raster from 120 encoded MacBlks.
   The corresponding pseudo-code (using the C programming language) that illustrates example software functions, procedures, and data structures that support random access of encoded MacBlks, either in raster or MacBlk order is given below. The pseudo-code is not intended to compile without errors using a C compiler, but instead is only intended to illustrate certain example data structures and software methods that could be used to implement the access encoder and decoder to provide such random access in either MacBlk or raster order.

FIG. 12 illustrates an example for use case 1 of an image sensor, a processor implementing operations of the access encoder, and a DDR memory using 2,048-Byte pages that stores encoded MacBlks. After the image sensor has captured an image, captured image sensor pixels are read raster by raster by the processor. The processor applies the access encoder to every raster received from the image sensor to produce a partially encoded MacBlk, for all 120 MacBlks that comprise a slice of 16 rasters. Sixteen rasters of 1920 pixels per raster=30,720 pixels; 30,720 pixels divided into 16×16 MacBlks creates 120 encoded MacBlks. For each input raster, the access encoder encodes pixels 1-16 of Raster 1 and stores the encoded values in the DDR memory allocated for MacBlk 1. Next, pixels 17-32 of Raster 1 are encoded and stored in the DDR memory allocated for MacBlk 2. Eventually, the final 16 pixels (pixels 1,905-1,920) of Raster 1 are encoded and stored in the DDR memory allocated for MacBlk 120 for the current slice of 120 encoded MacBlks. As the pixels from Raster 2 arrive, pixels 1-16 of Raster 2 are encoded and stored in the DDR memory region allocated for MacBlk 1 and are stored just after the encoded versions of Pixels 1-16 from Raster 1. Similarly, pixels 17-32 of Raster 2 are encoded and stored in the DDR memory region allocated for MacBlk 2, stored just after the encoded versions of Pixels 17-32 from Raster 1. The access encoding continues in this manner until pixels 1,905-1,920 from Raster 2 are encoded in the DDR memory region allocated for MacBlk 120, stored just after the encoded versions of Pixels 1,905-1,920 from Raster 1. Eventually, pixels from Raster 16 are processed by the access encoder. Pixels 1-16 from Raster 16 are encoded and stored in the DDR memory region allocated for MacBlk 1, stored just after the encoded versions of Pixels 1-16 from Raster 15. Similarly, pixels 17-32 from Raster 16 are encoded and stored in the DDR memory region allocated for MacBlk 2, stored just after the encoded versions of Pixels 17-32 from Raster 15. Processing continues in this manner until pixels 1,905-1,920 from Raster 16 are encoded in the DDR memory region allocated for MacBlk 120, stored just after the encoded versions of Pixels 1,905-1,920 from Raster 15. This completes access encoder processing of the Rasters 1-16 from the image sensor.

Access encoder processing continues in this way for subsequent slices of 16 rasters from the image sensor, filling encoded MacBlk regions in the allocated DDR addresses (9 MacBlks per DDR page) until all image sensor rasters have been encoded and stored. To summarize, after reading all 1,080 rasters from the image sensor, and filling 120 MacBlks per 16 rasters, 16 encoded pixels at a time, the access encoder has received 1,080 image sensor rasters and has stored 8,160 encoded MacBlks in DDR memory, accessing 120 encoded MacBlk regions in DDR memory per 16 rasters. In this example, the access encoder has stored the encoded MacBlks in half the DDR memory that would have been required to store the uncompressed YUV 4:2:0 pixels for this frame. Furthermore, the time taken to write the encoded pixels to DDR memory was also reduced by 2×, which decreases the power consumption of transferring and writing image sensor's pixels to DDR memory. Thus the access encoder provides both a capacity and a power savings to systems that capture and store image sensor data in DDR memory.

The C pseudo-code below illustrates an example of data structures and software methods useful for implementing the access encoding process for use case 1, just described with respect to FIG. 12. The pseudo-code is intended to illustrate how software that implements the access encoder can be created to control the writing of partial MacBlks (16 pixels at a time) to a group of 120 MacBlks for every 16 rasters provided by the image sensor. A function called “encodeFrame” converts rasters of pixels from an image sensor's 1080p frame into encoded MacBlks.

| | |
|---|---|
| 1 | function encodeFrame(int8 *frame, int32 |
| 2 | *DDR_start_addr, int32 *macBlkDir, single encRatio, |

| | |
|---|---|
| 3 | char pixelType) |

| | |
|---|---|
| 4 | { |

5

| | | |
|---|---|---|
| 6 | #define PIXELS_PER_RASTER = 1920; | // for 1080p frames |
| 7 | #define RASTERS_PER_FRAME = 1080; | // for 1080p frames |
| 8 | #define BYTES_PER_PIXEL = 1.5; | // Example for YUV |

| | |
|---|---|
| 9 | //4:2:0 encoding- depends on pixelType |
| 10 | //4:2:0 −> YYYYUV, so 6 Bytes/4 pixels |
| 11 | // = 1.5 Bytes / pixel |

| | | |
|---|---|---|
| 12 | #define DDR_PAGE_SIZE = 2048; | //for 2 kB / DDR page |
| 13 | #define PIXELS_PER_MB_ROW = 16; | // for 16 x 16 pixel |

| | |
|---|---|
| 14 | // macroblocks |

15

| | |
|---|---|
| 16 | #define IN_PTR_INC = PIXELS_PER_MB_ROW * |
| 17 | BYTES_PER_PIXEL; |

18

| | | |
|---|---|---|
| 19 | // | Allocate space for a local directory of MacBlk |

| | |
|---|---|
| 20 | // pointers(stores pointers to each MacBlk in current |
| 21 | // “slice” of rasters) |

22

| | |
|---|---|
| 23 | int32 rasterDir[ceil(PIXELS_PER_RASTER/ |
| 24 | PIXELS_PER_MB_ROW)]; |
| 25 | int16 encMBsize, MB_per_page; |

26

| | | |
|---|---|---|
| 27 | // | Slightly increase ENC_MB_SIZE, to allow room for |

| | |
|---|---|
| 28 | slightly larger encoded MacBlks. |

29

| 30 | encMBsize = ceil(IN_PTR_INC / encRatio); | |
|---|---|---|
| 31 | // | initial encoded macBlk size (no margin) |
| 32 | MB_per_page = floor(DDR_PAGE_SIZE / ENC_MB_SIZE); | |
| 33 | // | Calculate # of encoded MacBlks per page |

| | | |
|---|---|---|
| 34 | MB_per_page−−; | // Decrement MacBlks per page |

| | |
|---|---|
| 35 | //(“add margin”) |

| 36 | encMBsize = floor(DDR_PAGE_SIZE / Mb_per_page); | |
|---|---|---|
| 37 | // | Reduce encMBsize to include margin |

38

| | | |
|---|---|---|
| 39 | // | Initialize variables for the main raster-to-MacBlk |

| | |
|---|---|
| 40 | encoding loop. |

41

| | | |
|---|---|---|
| 42 | framePtr | = frame; |
| 43 | encPtr | = DDR_start_addr; |
| 44 | macBlkPtr | = &macBlkDir[0]; |

45

| | | |
|---|---|---|
| 46 | // | Encode the new image frame, |
| 47 | // | PIXELS_PER_MB_ROW rasters at a time |

48

| | |
|---|---|
| 49 | for (i=0; i < RASTERS_PER_FRAME; i += PIXELS_PER_MB_ROW) { |

50

| | | |
|---|---|---|
| 51 | // | Step thru the current raster PIXELS_PER_MB_ROW |
| 52 | // | rasters at a time. |

53

| | | |
|---|---|---|
| 54 | k = 0; | // init local MacBlk address counter |

| | |
|---|---|
| 55 | for (j=0; j < PIXELS_PER_RASTER; j += |

| | |
|---|---|
| 56 | PIXELS_PER_MB_ROW) { |

57

| | |
|---|---|
| 58 | // Every 16 rasters, save the pointers to the start |
| 59 | // of each compressed MacBlk, |
| 60 | // and initialize the local macBlks. |
| 61 | // Since the encoded size of PIXELS_PER_MB_ROW |
| 62 | // can vary, we need SEPARATE pointers to the |
| 63 | // (120 for 1080p) MacBlks per “slice”. |

64

| | |
|---|---|
| 65 | if ( i % 16 == 0) { |

| | |
|---|---|
| 66 | *macBlkPtr++ = encPtr; // save the start address |

| | |
|---|---|
| 67 | // of CURRENT macBlk |

| | |
|---|---|
| 68 | rasterPtr[k] = encPtr;// initialize LOCAL |

| | |
|---|---|
| 69 | // macBlkPtrs |

| | | |
|---|---|---|
| 70 | encPtr | += encMBsize; // advance pointer to |

| | |
|---|---|
| 71 | // point to the NEXT encoded macBlk |

| | |
|---|---|
| 72 | } |

73

| | |
|---|---|
| 74 | // Encode the current PIXELS_PER_MB_ROW, |
| 75 | // and write the results to DDR. |
| 76 | // Pass in k to give APAX encoder the context of |
| 77 | // the previous raster. |

78

| | |
|---|---|
| 79 | N_compBytes = APAX_encode_MB_row(framePtr, |

| | |
|---|---|
| 80 | rasterPtr[k], k, pixelType); |

81

| | | | |
|---|---|---|---|
| 82 | framePtr | += IN_PTR_INC; | // Advance pointer |

| | |
|---|---|
| 83 | // to input (un-encoded) frame |

| | | | |
|---|---|---|---|
| 84 | rasterPtr[k++] | += N_compBytes; | // Advance pointer |

| | |
|---|---|
| 85 | // to this encoded MacBlk |

| | |
|---|---|
| 86 | } |

87

| | |
|---|---|
| 88 | } |

The function encodeFrame uses the following parameters:
int8*frame—a pointer to the area of memory that contains the image sensor rasters.
The “frame” buffer may optionally consist of any of the following:
   “Wide” pixel register (all color components for one pixel per register read): A register address that provides a pixel per register read (for example, a pixel containing the 4:2:0 color components YYYYUV (six Bytes), each containing 8 bits per component.
   “Narrow” pixel register (one color component of a pixel per register read): A register address that provides individual color components; for example, when the register is read six times, it provides six Bytes {Y,Y,Y,Y,U,V} of color components for a pixel.
   For both “Wide” and “Narrow” pixel registers, the register is read once or 6 times, respectively, to retrieve a pixel's color components. Subsequent reads of the same register will return the next pixels color components in a pixel sequence that eventually returns all (1,080*1,920=) 2,073,600 pixels. A “wide” pixel register will have read the 1080p frame of this example in 2,073,600 processor clock cycles, while the “narrow” pixel register will require 6*2,073,600=12,441,600 processor clock cycles.
   A single- or double-buffered pixel buffer containing 1,920*6=11,520 Bytes. A preferred embodiment would use a double-buffered pixel buffer that typically generates an interrupt to the processor whenever a new raster has completely filled its corresponding buffer.
A DDR_start_addr start address indicating where the encoded MacBlks should be stored,
A directory of 32-bit (4-Byte) pointers (whose contents are filled by encodeFrame) supporting random access into 8,160 encoded MacBlks stored in DDR memory,
An encoding (or compression) ratio (encRatio) to be achieved by encodeFrame,
A pixelType specifier, indicating the color ordering (such as RGB or YUV) and color space decimation (if any, such as 4:2:2 or 4:2:0) of the incoming pixels.
   Lines 6-16 of the pseudo-code have six #define statements that define this example's imaging parameters:
pixels per raster (1920 in this example)
rasters per frame (1080 in this example)
bytes per pixel (1.5), for YUV 4:2:2 color encoding (the six bytes YYYYUV contain data for four pixels→6/4=1.5 Bytes per pixel)
DDR page size (2,048 in this example)
Pixels per MacBlk row (16 in this example), and
Frame (input) buffer pointer increment (16*1.5=24 in this example).
   Lines 23-4 declare a local rasterDir array that will store each slice's encoded MacBlk start addresses (pointers). For each ‘slice’ of 16 rasters being encoded into 120 MacBlks, the rasterDir array holds 120 pointers that are advanced with each 16 pixels per MacBlk. Using rasterDir in this way ensures that the encoded versions of groups of 16 pixels are packed into sequential Bytes in each 227-Byte encoded MacBlk allocation. The data structure rasterDir is useful because each of the 16-pixel groups per encoded MacBlk may encode to different sizes; to account for this possible size difference in encoding 16 pixels per raster, the rasterDir remembers the “partial progress” as it encodes each of the 120 MacBlks in this 16-raster ‘slice.’ The encMBsize variable contains the number of Bytes per encoded MacBlk, if every MacBlk fit into the average size. Lines 30-45 (preceded by the comment “Slightly increase encMBsize”) are instructions for the safety margin previously described with respect to FIG. 11, which stored only 9 MacBlks per DDR page (updated encMBsize), instead of the original 10 MacBlks per DDR page (original encMBsize). Lines 50-52 include instructions to initialize the input frame pointer (from which the image sensor pixels are read), the encoded buffer pointer (begins at the DDR memory start address), and a local MacBlk directory pointer (the first address stored in the MacBlkDir array of MacBlk start address pointers).

Lines 54-97 include pseudo-code that controls the access encoder's encoding operations, where a 16-raster slice is processed 1 raster at a time to build up 120 encoded MacBlks per 16-raster slice. The outer “for” loop (index i, line 58) iterates 16 rasters at a time for RASTERS_PER_FRAME, while the inner pseudo-code “for” loop (index j, line 64) iterates 16 pixels at a time for PIXELS_PER_RASTER. In this manner, the two control loops provide the APAX_encode_MB_row function (lines 88-9) with 16 pixels at a time to encode and to store at the address specified by rasterPtr[k]. The function APAX_encode_MB_row implements the compression operations applied to the samples in the macroblock row. In a preferred embodiment the compression operations comprise calculating sample differences followed by block floating point encoding. For each outer loop iteration (index i), index k is cleared, initializing the local rasterPtr index in the inner loop. At the start of each inner loop iteration, when j==0, the macBlkPtr value and local rasterPtr value are initialized, and the encoded buffer pointer is incremented by encMBsize. Each call to APAX_encode_MB_row encodes the current PIXEL_PER_MB_ROW input pixels into compressed data having a number of compressed Bytes, N_compBytes. Because N_compBytes returned by each APAX_encode_MB_row call may vary from call to call, the local rasterPtr array maintains separate pointers for each encoded MacBlk in this 16-raster ‘slice.’ Thus every time the function APAX_encode_MB_row is called, IN_PTR_INC bytes are consumed from the input raster, while N_compBytes encoded bytes are generated. After the inner and outer loops complete, the pseudo-code has generated 8,160 encoded MacBlks and 8,160 encoded MacBlk pointers, stored in the macBlkDir array.

FIG. 13 illustrates an example of use case 2 where a processor performing MacBlk-based video compression or decompression uses access encoding and decoding for random access of MacBlks. MacBlk-based video codecs, such as H.264 video codecs, operate on MacBlks of image pixel data for motion estimation (ME) processes and motion compensation (MC) processes. During ME processing, the processor applies access encoder logic to the un-encoded MacBlks and stores encoded MacBlks in DDR memory. During MC processing, the processor retrieves encoded MacBlks for access decoder logic, which provides decoded MacBlks for MC operations. When a MacBlk-based video compressor or decompressor, such as H.264, requests a MacBlk from DDR memory during MC or ME operations, the access decoder retrieves the encoded version of the requested MacBlk from DDR memory, decodes the encoded MacBlk, and returns the decoded MacBlk to the requesting function.

The C pseudo-code below illustrates an example of data structures and software methods useful for implementing the access decoding operations. The pseudo-code for a function called getMacBlk retrieves the encoded version of the specified (requested) MacBlk from DDR memory and returns the decoded version of that MacBlk to the calling function. The access decoder decodes the encoded MacBlk to re-create the pixels of the requested MacBlk.

| 1 | function getMacBlk(int16 macBlkNum, int32 *macBlkDir, | |
|---|---|---|
| 2 | int8 *macBlkPixels, char pixelType) | |
| 3 | { | |
| 4 | | |
| 5 | int32 *macBlkAddr; | |
| 6 | | |
| 7 | // Initalize the start address of the desired MacBlk, | |
| 8 | // | using the encoded MacBlk directory. |

| | |
|---|---|
| 9 | |
| 10 | macBlkAddr = macBlkDir[macBlkNum]; |
| 11 | |
| 12 | // Decode the desired MacBlk, and store decoded |
| 13 | // pixels (according to pixelType) at macBlkPixels[ ]. |
| 14 | |
| 15 | APAX_decode_MB(MacBlkAddr, macBlkPixels, pixelType); |
| 16 | |
| 17 | return; |
| 18 | } |

///

The function getMacBlk is given the requested MacBlk number, macBlkNum, and is also given macBlkDir (an array of encoded MacBlk pointers), and the address where the decoded MacBlk's pixels shall be stored (macPlkPixels). The getMacBlk function first calculates the DDR memory start address for macBlkNum by retrieving that block's starting address (macBlkAddr) from the array (macBlkDir) of encoded MacBlk start addresses. The function APAX_decode_MB (line 15) decodes the encoded MacBlk whose encoded values begin at address macBlkAddr, and stores the decoded pixels into the macBlkPixels memory buffer. The function APAX_decode_MB is also provided with the pixelType, such as RGB 4:4:4 or YUV 4:2:2, of the requested color component and their width. In a preferred embodiment, the function APAX_decode_MB performs block floating point decoding and integration operations to invert the operations of the function APAX_encode_MB_row described above.

FIG. 14 illustrates an example of use case 3 where the access decoder accesses encoded MacBlks in a certain sequence that returns decoded pixels, raster by raster, to a display device, such as the display of a mobile phone, a tablet computer, or a television display. A processor may apply the access decoder to perform an encoded MacBlk-to-raster decoding process. The access decoder fetches encoded MacBlks in a certain sequence and returns one raster (1,920 pixels in this example) at a time to a display device, whose preferred order of receiving display pixels is in raster order. The access decoder accesses a “slice” of encoded MacBlks 16 pixels at a time, decoding 16 output pixels from each of 120 encoded MacBlks (in this example).

The C pseudo-code below illustrates an example of how certain data structures and software methods can implement the access decoding and MacBlk-to-raster operations. The function decodeFrame includes input parameters for the DDR start address of the first encoded MacBlk, a directory of pointers into the encoded frame (one pointer or start address per encoded MacBlk), a pointer to where the decoded pixels should be stored (one raster at a time), and a pixelType parameter that indicates the color components and color decimation parameters of the encoded MacBlks.

| | |
|---|---|
| 1 | function decodeFrame(int32 *DDR_start_addr, int32 |
| 2 | *macBlkDir, int8 *frame, char pixelType) |

| | |
|---|---|
| 3 | { |

4

| 5 | #define PIXELS_PER_RASTER = 1920; | // Example for |
|---|---|---|
| 6 | | // 1080p frames |
| 7 | #define RASTERS_PER_FRAME = 1080; | // Example for |
| 8 | | // 1080p frames |
| 9 | #define BYTES_PER_PIXEL = 1.5; | // Example for YUV |

| | |
|---|---|
| 10 | // 4:2:0 encoding depends on pixelType |
| 11 | // 4:2:0 −> YYYYUV, so 6 Bytes/4 pixels |
| 12 | // = 1.5 Bytes / pixel |

| 13 | #define DDR_PAGE_SIZE = 2048; | // Example for 2 kB |
|---|---|---|
| 14 | | // per DDR page |
| 15 | #define PIXELS_PER_MB_ROW = 16; | // Example for 16x16 |

| | |
|---|---|
| 16 | // pixel macroblocks |

17

| | |
|---|---|
| 18 | #define IN_PTR_INC = PIXELS_PER_MB_ROW * |
| 19 | BYTES_PER_PIXEL; |

20

| | | |
|---|---|---|
| 21 | // | Allocate space for a local directory of MacBlk |
| 22 | // | pointers (stores pointers) |

| | | |
|---|---|---|
| 23 | // | to each MacBlk in current “slice” of rasters) |

24

| | |
|---|---|
| 25 | Int32 rasterDir[ceil(PIXELS_PER_RASTER / |
| 26 | PIXELS_PER_MB_ROW)]; |

27

| | | |
|---|---|---|
| 28 | // | Initialize variables for the main MacBlk-to-Raster |
| 29 | // | decoding loop. |

30

| | |
|---|---|
| 31 | framePtr = frame; |

32

| | | |
|---|---|---|
| 33 | // | Decode the encoded image frame, one raster at a |
| 34 | // | time, by accessing encoded MacBlks. |

35

| | |
|---|---|
| 36 | k0 = 0; |
| 37 | for (i=0; i < RASTERS_PER_FRAME; i++) { |

38

| | |
|---|---|
| 39 | // Decode pixels for the current raster. |

40

| | |
|---|---|
| 41 | k = 0; // reset the index to local MacBlk pointers |

42

| | |
|---|---|
| 43 | for (j=0; j < PIXELS_PER_RASTER; j += |

| | |
|---|---|
| 44 | PIXELS_PER_MB_ROW) { |

45

| | |
|---|---|
| 46 | // Every 16 rasters, initialize the local |
| 47 | // MacBlk ptrs for this “slice” of MacBlks. |

48

| | |
|---|---|
| 49 | if ( i % 16 == 0) { |

| | |
|---|---|
| 50 | // initialize the LOCAL macBlkPtrs |
| 51 | rasterPtr[k] = macBlkDir[k0++] |

| | |
|---|---|
| 52 | } |

53

| | | |
|---|---|---|
| 54 | // | Decode PIXELS_PER_MB_ROW pixels, and write |
| 55 | // | the decoded results to DDR. |
| 56 | // | Pass in the MacBlk index k, to provide |
| 57 | // | APAX decoder with context (prev. raster) |

58

| | |
|---|---|
| 59 | NencBytes = APAX_decode_MB_row(rasterPtr[k], |

| | |
|---|---|
| 60 | k, framePtr, pixelType); |

| | |
|---|---|
| 61 | // Advance local pointer into the current MacBlk |

| | | |
|---|---|---|
| 62 | rasterPtr[k++] | += NencBytes; |

| | |
|---|---|
| 63 | // Advance pointer into input (un-encoded) frame |

| | | |
|---|---|---|
| 64 | framePtr | += IN_PTR_INC; |

| | |
|---|---|
| 65 | } |

66

| | |
|---|---|
| 67 | } |

68

| | |
|---|---|
| 69 | return; |

| | |
|---|---|
| 70 | } |

///

The decodeFrame function initializes various constants such as PIXELS_PER_RASTER and RASTERS_PER_FRAME, and allocates space for a local rasterDir array that stores pointers for each decoded MacBlk. The local rasterDir array (line 25) is needed because each encoded MacBlk may use a different number of Bytes for each group of 16 encoded pixels. Thus each encoded MacBlk can be decoded by different amounts as the decoded rasters are created by decodeFrame. A local frame pointer (framePtr, line 31) is initialized to point at the first byte of the decoded raster. The decoded frame buffer may occupy a contiguous area of memory large enough to hold the entire frame, to hold just one raster of the frame, to hold just one pixel of the current raster (such as the “wide” register described above), or to hold just one Byte (one color component) of the current pixel (such as the “narrow” register described above).

The decodeFrame's outer loop, beginning at line 37, iterates over all rasters in the frame (in this example, one raster at a time). The decodeFrame's inner loop, beginning at line 43, generates 16 pixels at a time, where the 16 pixels are decoded from one of 120 encoded MacBlks in this example. The pointers into the 120 encoded MacBlks are stored in the local rasterPtr array, whose index k is incremented 120 times per decoded raster of 1,920 pixels in this example. Since the number of encoded Bytes that corresponds to every 16 decoded pixels can vary from MacBlk to MacBlk, the APAX_decode_MB_row function returns the variable NencBytes, which advances the local rasterPtr address with every 16 decoded pixels (line 59). After 16 pixels have been decoded from each of 120 encoded MacBlks, the 1,920 pixel raster can be written to the raster-oriented display register, buffer, or frame.

The use cases described with respect to FIGS. 12, 13 and 14 are examples of applying the access encoder and decoder for:
a. generating encoded MacBlks from an input stream of image sensor rasters,
b. generating an output stream of display rasters from encoded MacBlks, and
c. generating decoded MacBlks given a desired macBlkNum and an array of pointers holding the start addresses of the encoded MacBlks.

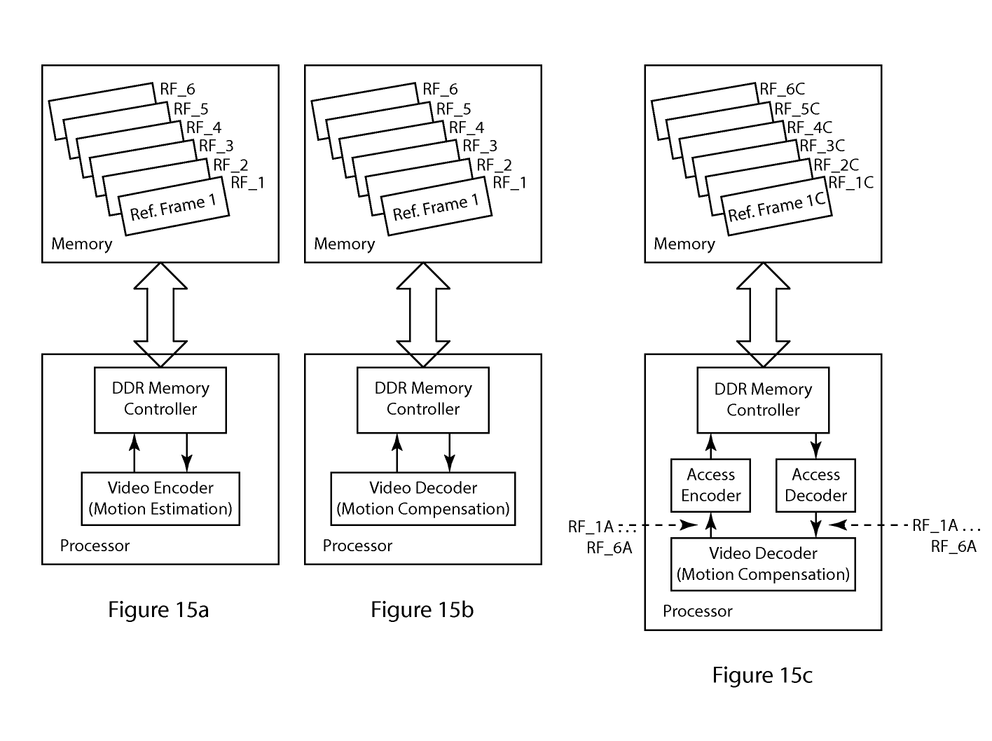

FIGS. 15a and 15b illustrate examples of macroblock-based video encoding and decoding algorithms, such as MPEG2, H.264, and H.265 (HEVC), that use one or more reference frames stored in a memory for encoding a current frame of pixels. The macroblock-based video encoding algorithms have previously encoded the reference frames, decoded the encoded reference frames and stored the previously decoded reference frames RF_{—}1 to RF_{—}6 for use in motion estimation calculations for encoding the current frame. FIG. 15a illustrates an example of a video encoder where previously decoded reference frames are stored in a memory. For this example, six previously decoded reference frames RF_{—}1 to RF_{—}6, are stored in the memory in uncompressed (unencoded) form, in formats such as RGB or YUV 4:2:0. RF_{—}1 is the reference frame immediately preceding the current frame being decoded. The video encoder's processor may access one or more macroblocks in any of the previously decoded reference frames RF_{—}1 thru RF_{—}6 during the motion estimation process to identify a similar macroblock to the current macroblock in the frame currently being encoded. A reference to that most similar macroblock in the one or more reference frames RF_{—}1 thru RF_{—}6 in this example is then stored in the encoded video stream as a “motion vector.” The motion vector identifies the most similar prior macroblock in the reference frames RF_{—}1 thru RF_{—}6, possibly interpolated to the nearest ½ or ¼-pel location. As shown in FIG. 15b, the video decoder stores the same previously decoded reference frames RF_{—}1 thru RF_{—}6 during motion compensation as did the video encoder during motion estimation. The video decoder retrieves the macroblock in the previously decoded reference frame corresponding to the motion vector. The video decoder optionally interpolates the most-similar macroblock's pixels by ½ or ¼-pel, as did the video encoder. In this manner, both the video encoder shown in FIG. 15a and the video decoder shown in FIG. 15b reference the same reference frames while encoding and decoding a sequence of images of a video.

FIG. 15c illustrates an example of the access encoder and access decoder providing memory access during the video decoder's motion compensation process. During macroblock-based decoding of a current frame, the access encoder stores re-encoded (compressed) versions of the MacBlks that comprise reference frames RF 1C thru RF_{—}6C; these MacBlks replace those originally associated with the MacBlks of the previously decoded reference frames RF_{—}1 thru RF_{—}6 of FIG. 15b. As the video decoder requests one or more macroblocks found within reference frames RF 1C thru RF_{—}6C (depending on the motion vector associated with the MacBlk), the access decoder identifies the location of the requested macroblock in the memory containing re-encoded MacBlks, and decodes the re-encoded macroblock to form a decoded MacBlk. The access decoder provides the requested one or more macroblock(s) for the motion compensation processes for the current frame. The decoded macroblocks in reference frames RF_{—}1A-RF_{—}6A may be approximations of the uncompressed macroblocks from reference frames RF_{—}1-RF_{—}6 of FIG. 15b. Because the pixels in the approximated macroblock may not be identical to pixels in the original macroblock (i.e. the motion-estimated macroblock that the video encoder used), a difference may exist between the decoded (approximated) macroblock, compared to the original macroblock.

Depending on the distance between “anchor” frames (also called P frames), the difference between the approximated macroblock and the original macroblock may cause some amount of ‘drift’ in the interpolated frames (also called I frames) between P frames. In macroblock-based video encoding algorithms, such as MPEG2, H.264, and H.265 (HEVC), the distance between P frames is called the Group Of Pictures (GOP) distance. GOP distance is a user-selectable parameter of the video encoding algorithm. The smaller the GOP distance, the more likely that the approximated macroblocks of the reference frames RF_{—}1A-RF_{—}6A (FIG. 15c) will closely resemble the uncompressed, non-approximated macroblocks of the reference frames RF_{—}1-RF_{—}6 (FIGS. 15a, 15b) that were used during the video encoding process. The “drift” that lossy encoding of MacBlks may introduce during H.264 or similar MacBlk-based decoding may not be objectionable; the smaller (shorter) the GOP distance, the less likely that the “drift” will be objectionable. In fact, users may prefer to control the access encoder's degree of loss (encoding or compression ratio), because the degree of loss is proportional to an increase in battery life. By giving the control of the access encoder's degree of loss through a user interface, users can control the tradeoff between decoded video quality and battery life, for example, on the mobile devices (smart phones, tablet computers, or similar) that are decoding video. This degree of control is presently not available on mobile devices, but may be a desirable feature that mobile device users would want to control.

The access encoder of FIG. 15c may include a lossless encoding mode, so that macroblocks in the re-encoded (compressed) reference frame (RF 1C to RF_{—}6C) can be decoded by the access decoder to generate identical macroblocks and reference frames (RF_{—}1 to RF_{—}6) used by the video encoder of FIG. 15a. In this manner, the access encoder and decoder can operate either in a standard-conformant mode, i.e. a lossless mode, or in a power-saving mode, i.e. a lossy mode. For example, the selection a standard-conformant mode or a power-saving mode for video codecs of a mobile device may be controlled by the user via a user interface. The lossless mode of the access encoder would provide the standard-conformant mode, since the reference frames RF_{—}1A to RF_{—}6A would be identical to those reference frames RF_{—}1 to RF_{—}6 used by the video encoder. The lossy mode of the access encoder would provide a power-saving mode and the reference frames RF 1 A to RF_{—}6A would approximate those reference frames RF_{—}1 to RF_{—}6 used by the video encoder. In the power-saving (lossy MacBlk access encode/decode) mode, the degree of loss may be chosen by the user of the mobile device via a user interface.

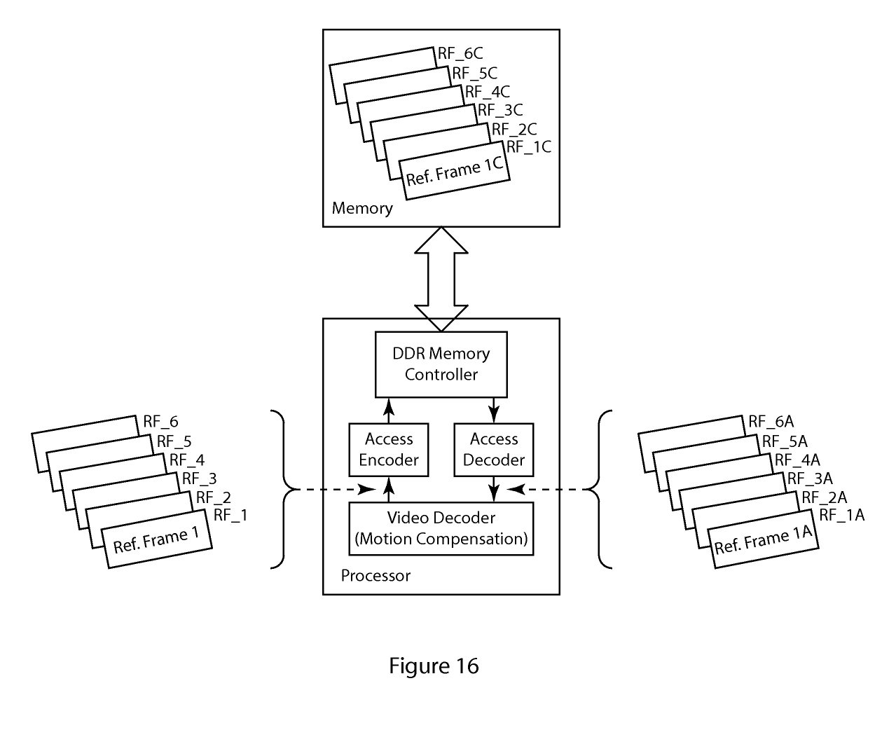

FIG. 16 illustrates examples of the three types of MacBlks that are processed by the access encoder/decoder for video decoding. The input to the access encoder are MacBlks from un-encoded reference frames, identified in FIG. 16 as example input reference frames RF_{—}1 thru RF_{—}6. The video decoder decodes a portion of the received encoded (compressed) video stream to produce the un-encoded reference frames. The access encoder converts one or more MacBlks from RF 1 thru RF 6 into encoded MacBlks and stores the encoded MacBlks in an external memory. Thus the access encoder creates encoded (compressed) reference frames RF_{—}1C to RF_{—}6C from the MacBlks of input reference frames RF_{—}1 thru RF_{—}6 in this example. The encoded reference frames RF_{—}1C to RF_{—}6C are stored for use in decoding a current frame. The access decoder retrieves one or more encoded (compressed) MacBlks from RF_{—}1C thru RF_{—}6C, indicated by the motion vector for the MacBlk currently being decoded for the current frame, and returns the associated decoded (decompressed; approximated) MacBlks. Thus the access decoder creates decoded (approximated) reference frames RF_{—}1A to RF_{—}6A from the MacBlks of encoded reference frames RF_{—}1C thru RF_{—}6C in this example. When the access encode-decode process operates in its lossless mode, pixels in MacBlks from RF_{—}1A thru RF_{—}6A will be identical to the pixels in MacBlks from RF_{—}1 thru RF_{—}6 in this example. When the access encode-decode process operates in its lossy mode, pixels in MacBlks from RF_{—}1A thru RF_{—}6A will approximate the pixels in MacBlks from RF_{—}1 thru RF_{—}6 in this example.

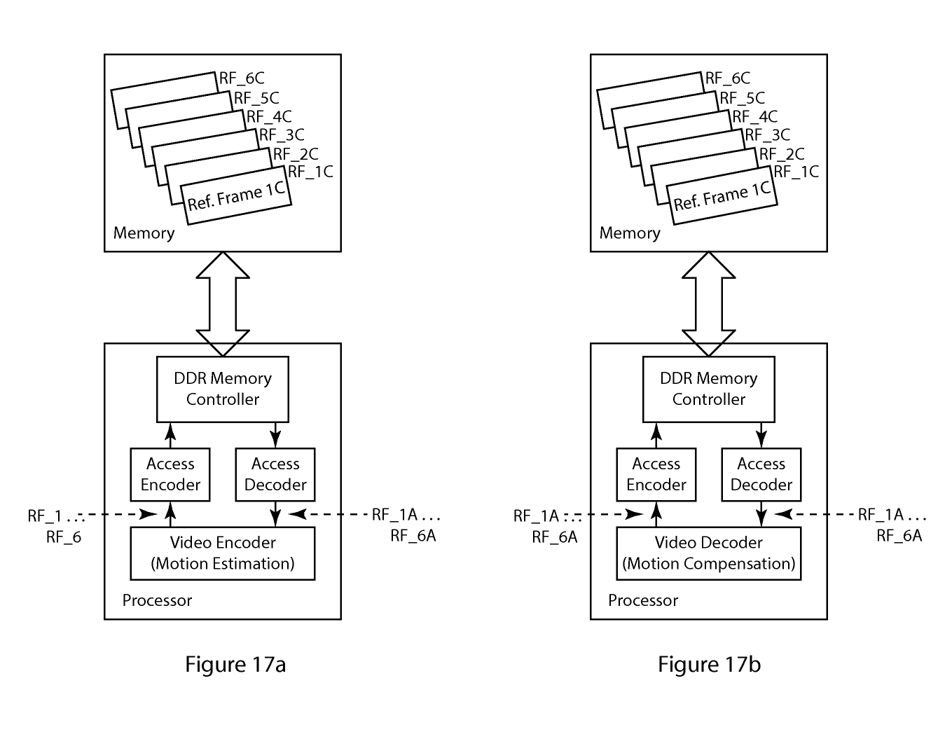

FIGS. 17a and 17b illustrate examples of systems in which a video encoder and a video decoder include an access encoder and an access decoder. FIG. 17a illustrates a video encoder system that includes an access encoder and an access decoder. The access encoder encodes MacBlks of reference frames to be used by video encoder, which stores encoded (compressed) MacBlks. The access decoder retrieves and decodes encoded MacBlks to provide decoded (decompressed) MacBlks from reference frames during the video encoder's Motion Estimation (ME) process. FIG. 17b illustrates a video decoder system that includes an access encoder and an access decoder. The access encoder encodes MacBlks of reference frames to be used by the video decoder, which stores the encoded (compressed) MacBlks. The access decoder retrieves and decodes the encoded MacBlks to provide decoded (decompressed) MacBlks from reference frames during the video decoder's Motion Compensation (MC) process. When the settings (lossless/lossy mode setting, and for lossy encoding, the lossy encoding, or compression, rate) of the access encoder/decoder pair are identical in the video encoder (FIG. 17a) and video decoder (FIG. 17b), the decoded MacBlks from approximated reference frames RF_{—}1A thru RF_{—}6A in this example will be identical in both the video encoder (FIG. 17a) and the video decoder (FIG. 17b). The “drift” problem (described with reference to FIG. 15c) will not occur, since both the video encoder (FIG. 17a) and video decoder (FIG. 17b) will generate identical MacBlks from the encoded MacBlks stored in encoded (compressed) reference frames RF_{—}1C thru RF_{—}6C. Decoded MacBlks in both the video encoder (FIG. 17a) and video decoder (FIG. 17b) will be identical, regardless of the operating mode (lossless or lossy) and the encoding (compression) rate for the lossy mode. Thus, the video encoder system and video decoder system can use the access encoder/decoder in the lossy or lossless mode, without introducing the previously described “drift” problem for I frames. These modes and the encoding rate (compression ratio) may be selectable by the user via a user interface.

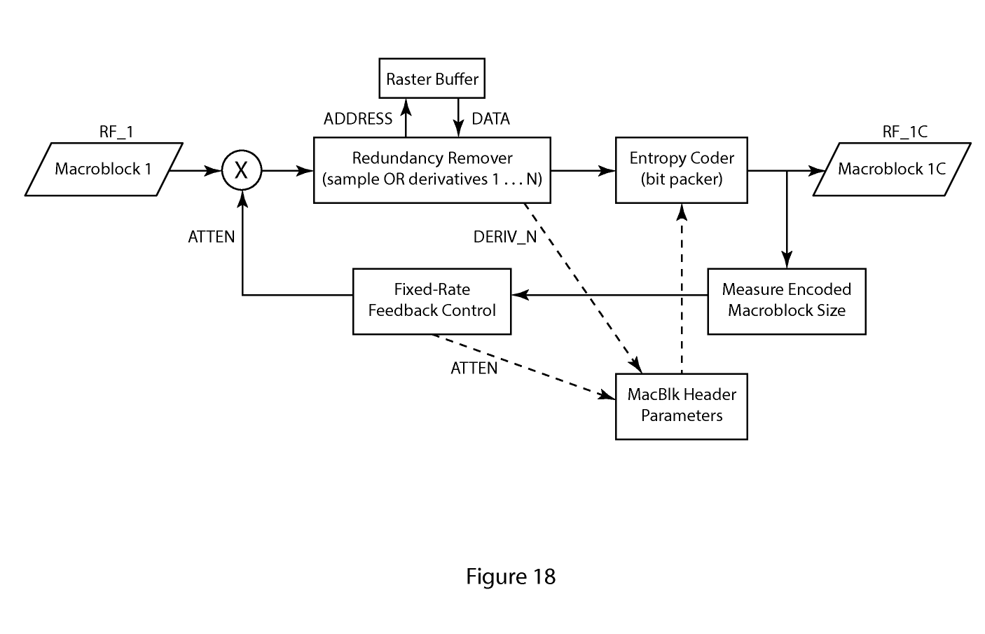

FIG. 18 is a block diagram of the access encoder, in accordance with a preferred embodiment. Aspects of these access encoder components are described in the '533 patent, the '205 application, and the '511 application. The access encoder includes an attenuator, a redundancy remover, and an entropy coder. A preferred embodiment of the entropy encoder comprises a block exponent encoder and joint exponent encoder, as described in the '803 patent. The redundancy remover may store one or more previous rasters (rows of pixels) in a raster buffer. The raster buffer enables the redundancy remover to select from among three alternative image component streams:

1. The original image components (such as RGB or YUV),
2. The first difference between corresponding image components, where the variable
“i” indicates the current image component along a row or raster, such as:
i. R(i)-R(i−1), followed by
ii. G(i)-G(i−1), followed by
iii. B(i)-B(i−1); or
iv. Y(i)-Y(i−1), followed by
v. U(i)-U(i−1), followed by
vi. V(i)-V(i−1)
3. The difference between corresponding image components from the previous row (raster), where the variable i indicates the current image component along a row or raster, and the variable j indicates the current row or raster number, such as:
i. R(i,j)-R(i,j−1), followed by
ii. G(I,j)-G(i,j−1), followed by
iii. B(i,j)-B(i,j−1); or
iv. Y(i,j)-Y(i,j−1), followed by
v. U(i,j)-U(i,j−1), followed by
vi. V(i,j)-V(i,j−1)

During the encoding of the current MacBlk, the redundancy remover determines which of these three streams will use the fewest bits, i.e. will compress the most. That stream is selected as the “best derivative” for the next encoded MacBlk. The “best derivative” selection is encoded in the encoded MacBlk's header (as indicated by the DERIV_N parameter in FIG. 18). The entropy coder receives the selected derivative samples from the redundancy remover applies block floating point encoding and joint exponent encoding to the selected derivative samples. The block floating point encoding determines the maximum exponent values of groups of the derivative samples. The maximum exponent value corresponds to the place value (base 2) of the maximum valued sample in the group. Joint exponent encoding is applied to the maximum exponents for a sequence of groups to form exponent tokens. The mantissas of the derivative samples in the group are represented by a reduced number of bits based on the maximum exponent value for the group. The sign extension bits of the mantissas for two's complement representations or leading zeroes for sign-magnitude representations are removed to reduce the number of bits to represent the encoded mantissas. The parameters of the encoded MacBlk may be stored in a header. The entropy coder may combine the header with the exponent tokens and encoded mantissa groups to create an encoded MacBlk. To support fixed-rate encoding, in which a user can specify a desired encoding rate, the access encoder of FIG. 18 includes a block to measure the encoded MacBlk size for each encoded MacBlk. A fixed-rate feedback control block uses the encoded MacBlk size to adjust the attenuator setting (ATTEN). More attenuation (smaller ATTEN value) will reduce the magnitudes of all three candidate streams provided to the redundancy remover, and thus will increase the encoding (compression) ratio achieved by the access encoder of FIG. 18. Averaged over several encoded MacBlks, the fixed-rate feedback control may achieve the user-specified encoding rate. The access encoder generates one or more encoded MacBlks. A number of encoded MacBlks comprise encoded reference frame RF_{—}1C as shown in FIG. 18.

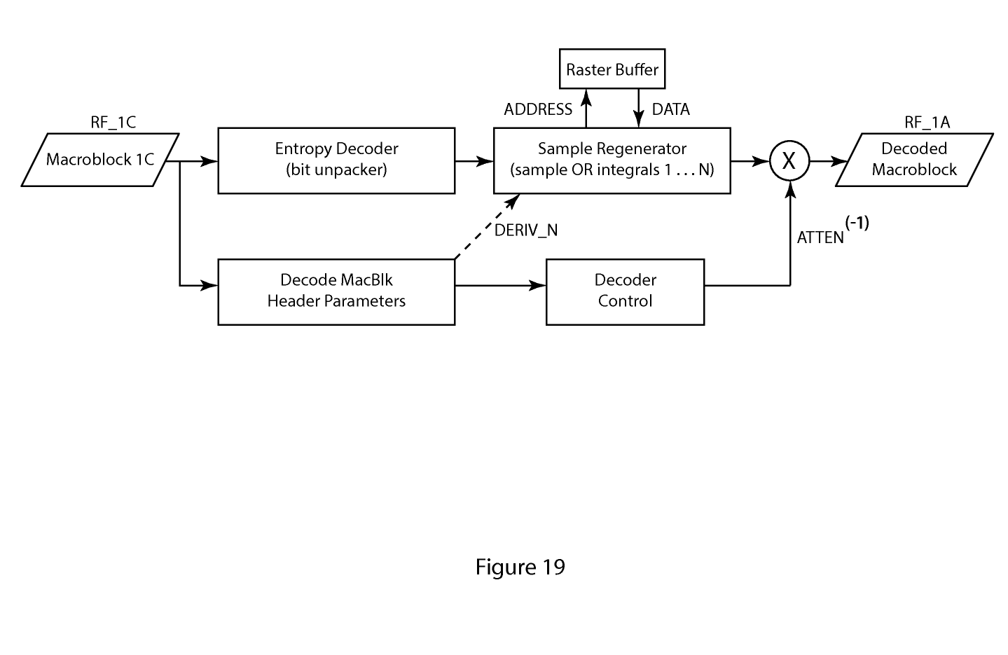

FIG. 19 is a block diagram of an access decoder, in accordance with a preferred embodiment. Aspects of these decoder components are described in the '533 patent, the '205 application, and the '511 application. The access decoder preferably includes an entropy decoder, a signal regenerator, and a gain block (multiplier). The entropy decoder preferably comprises block floating point decoder and joint exponent decoder (JED), further described in the '803 patent. A state machine in the access decoder (not shown in FIG. 19) separates the encoded MacBlks into header and payload sections, and passes the header sections to a block header decoder, which decodes MacBlk header parameters such as DERIV_N and ATTEN. The signal regenerator block inverts the operations of the redundancy remover in accordance with the parameter DERIV_N provided in the encoded macroblock's header. For example, when the redundancy remover selected original image components the signal regenerator provides decoded image components. For another example, when the redundancy remover selected image component pixel differences or image component raster/row differences, the signal regenerator would integrate, or add, the pixel differences or raster/row differences, respectively, to produce decoded image components. The signal regenerator stores the decoded image components from one or more previous rasters (rows of pixels) in a raster buffer. These decoded image components are used when the MacBlks was encoded using the previous row/raster's image components by the access encoder, as described with respect to FIG. 18. The inverse of the parameter ATTEN is used by the gain block (multiplier) of FIG. 19 to increase the magnitude of regenerated samples from the sample regenerator block. The access decoder generates one or more decoded MacBlks. A number of decoded MacBlks comprise a decoded reference frame RF_{—}1A as shown in FIG. 19. When the access encoder operates in a lossless mode, the decoded MacBlks of RF_{—}1A (FIG. 19) will be identical to MacBlks of the input reference frame RF_{—}1. When the access encoder operates in a lossy mode, the decoded MacBlks of RF_{—}1A (FIG. 19) will approximate the MacBlks of the input reference frame RF_{—}1. In a preferred embodiment of the lossy mode, the difference between the approximated MacBlks and the original MacBlks is selected or controlled by a user. The larger the encoding ratio, the larger the difference between the approximated and original (input) MacBlks, but also the greater the savings in power consumption and the greater the battery life of a mobile device that utilizes the flexible, adaptive, user-controlled access encoder/decoder.

The access encoder/decoder can reduce the amount of DDR memory required to store reference frames in image compression applications such as H.264 and similar algorithms that encode image frames using MacBlks, as well as the time required to access the reference frame's pixels. The access encoder/decoder can also reduce the amount of memory required to capture image sensor frames, and to store display frames. The access encoder/decoder allows for variation in frame dimensions (PIXELS_PER_RASTER and RASTERS_PER_FRAME), macroblock dimensions (PIXELS_PER_MB_ROW), pixel color encoding and color space decimation (BYTES_PER_PIXEL and pixelType), encoding (compression) ratio (encRatio), and DDR memory page size (DDR_PAGE_SIZE). The access encoder/decoder provides a flexible, user-controllable method of reducing both DDR memory capacity and memory bandwidth required for common image capture, processing, storage, and display functions. Speed and latency of the access encoding and decoding processes can be modified by varying the number of pipeline stages in the combinatorial logic for the flexible encoding and decoding functions. Other implementations of the access encoder and decoder functions may use dedicated input and output registers in addition to or instead of the memory and registers described in the examples of the present specification.

A variety of implementation alternatives exist for the embodiments of the access encoder and access decoder, such as implementation in a microprocessor, graphics processor, digital signal processor, field-programmable gate array (FPGA), application-specific integrated circuit (ASIC), or system-on-chip (SoC). The implementations can include logic to perform the access encoding and access decoding processes described herein, where the logic can include dedicated logic circuits, configurable logic such as field programmable logic array FPGA blocks, configured to perform the functions, general purpose processors or digital signal processors that are programmed to perform the functions, and various combinations thereof.

The access encoder and access decoder operations can be implemented in hardware, software or a combination of both, and incorporated in computing systems. The hardware implementations include ASIC, FPGA or an intellectual property (IP) block for a SoC. The access encoder and access decoder operations can be implemented in software or firmware on a programmable processor, such as a digital signal processor (DSP), microprocessor, microcontroller, multi-core CPU, or GPU.

In one embodiment for a programmable processor, programs including instructions for operations of the access encoder and access decoder are provided in a library accessible to the processor. The library is accessed by a compiler, which links the application programs to the components of the library selected by the programmer. Access to the library by a compiler can be accomplished using a header file (for example, a file having a “.h” file name extension) that specifies the parameters for the library functions and corresponding library file (for example, a file having a “.lib” file name extension, a “.obj” file name extension for a Windows operating system, or a file having a “.so” file name extension for a Linux operating system) that use the parameters and implement the operations for the access encoder/decoder. The components linked by the compiler to applications to be run by the computer are stored, possibly as compiled object code, for execution as called by the application. In other embodiments, the library can include components that can be dynamically linked to applications, and such dynamically linkable components are stored in the computer system memory, possibly as compiled object code, for execution as called by the application. The linked or dynamically linkable components may comprise part of an application programming interface (API) that may include parameters for compression operations as described in the '898 application.

For implementation using FPGA circuits, the technology described here can include a memory storing a machine readable specification of the access encoder logic, and a machine readable specification of the access decoder logic, in the form of a configuration file for the FPGA block. For the systems shown in FIGS. 1, 12-19, optionally including additional components, the access encoder and access decoder may be described using computer aided design tools and expressed (or represented), as data and/or instructions embodied in various computer-readable media, in terms of their behavioral, register transfer, logic component, transistor, layout geometry, and/or other characteristics. A machine readable specification of the access encoder logic and a machine readable specification of the access decoder logic can be implemented in the form of such behavioral, register transfer, logic component, transistor, layout geometry and/or other characteristics. Formats of files and other objects in which such circuit expressions may be implemented include, but are not limited to, formats supporting behavioral languages such as C, Verilog, and VHDL, formats supporting register level description languages like RTL, and formats supporting geometry description languages such as GDSII, GDSIII, GDSIV, CIF, MEBES and any other suitable formats and languages. A memory including computer-readable media in which such formatted data and/or instructions may be embodied include, but are not limited to, computer storage media in various forms (e.g., optical, magnetic or semiconductor storage media, whether independently distributed in that manner, or stored “in situ” in an operating system).

When received within a computer system via one or more computer-readable media, such data and/or instruction-based expressions of the above described circuits may be processed by a processing entity (e.g., one or more processors) within the computer system in conjunction with execution of one or more other computer programs including, without limitation, netlist generation programs, place and route programs and the like, to generate a representation or image of a physical manifestation of such circuits. Such representation or image may thereafter be used in device fabrication, for example, by enabling generation of one or more masks that are used to form various components of the circuits in a device fabrication process.

While the preferred embodiments of the invention have been illustrated and described, it will be clear that the invention is not limited to these embodiments only. Numerous modifications, changes, variations, substitutions and equivalents will be apparent to those skilled in the art, without departing from the spirit and scope of the invention, as described in the claims.

What is claimed is:

1. A method, comprising:
receiving image samples in a raster format at a processor;
encoding a sequence of sets of image samples from each raster in a sequence rasters of the raster format to form a plurality of encoded macroblocks, wherein a number of samples in the set corresponds to a first macroblock dimension and a number of rasters in the sequence of rasters corresponds to a second macroblock dimension;
calculating a size of each encoded macroblock;
generating a directory of pointers to macroblock addresses based on the size of each encoded macroblock; and
storing the encoded macroblocks in memory.

2. The method of claim 1, further comprising:
determining a macroblock address for a desired encoded macroblock using the directory of pointers;
retrieving the desired encoded macroblock from the memory in accordance with the macroblock address;
decoding the desired encoded macroblock to produce a decoded macroblock.

3. A method, comprising:
receiving an unencoded video frame in a macroblock format;
encoding each macroblock of the unencoded video frame to form a plurality of encoded macroblocks corresponding to the video frame;
calculating a size of each encoded macroblock in the plurality of encoded macroblocks;
generating a directory of pointers to macroblock addresses for the plurality of encoded macroblocks corresponding to the video frame based on the size of each encoded macroblock; and
storing the plurality of encoded macroblocks in memory.

4. The method of claim 3, further comprising:
determining a macroblock address for a desired encoded macroblock from the plurality of encoded macroblocks using the directory of pointers;
retrieving the desired encoded macroblock from the memory in accordance with the macroblock address;
decoding the desired encoded macroblock to produce a decoded macroblock.

5. A method, comprising:
receiving a plurality of image samples in a macroblock format, comprising a sequence of macroblocks, wherein the sequence of macroblocks contains image samples for a plurality of rasters;
encoding each macroblock in the sequence of macroblocks to form a sequence of encoded macroblocks;
calculating a size of each encoded macroblock in the sequence of encoded macroblocks;
generating a directory of pointers to macroblock addresses for the sequence of encoded macroblocks based on the size of each encoded macroblock; and
storing the sequence of encoded macroblocks in memory.

6. The method of claim 5, further comprising:
for a given raster, selecting an encoded row in the encoded macroblocks of the sequence of encoded macroblocks using the directory of pointers, wherein the selected encoded row in each of the encoded macroblocks corresponds to a respective portion of a desired raster of the image samples;
retrieving encoded rows from the memory; and
decoding the encoded rows to form respective portions of the desired raster.
